(19) United States
(12) Patent Application Publication
(10) Pub. No.: US 2025/0061391 A1
(43) Pub. Date: Feb. 20, 2025

(54) VIDEO-BASED CONFIGURATION OF A PROFILE FOR A PROJECT TO BE PERFORMED AT A PHYSICAL LOCATION

(71) Applicant: Fixvi Inc., Ottawa (CA)

(72) Inventors: Jeffrey Keith GORDON, Gloucester (CA); Cameron Michael CROMPTON, Ottawa (CA); Graham Bristo Nicholas SCHENCK, St. Catherines (CA); Mark Andrew ELLIS, Ottawa (CA)

(73) Assignee: Fixvi Inc., Ottawa, ON (CA)

(21) Appl. No.: 18/452,303

(22) Filed: Aug. 18, 2023

(51) Int. Cl. G06Q 10/0631; G06V 20/52; G10L 15/26

(52) U.S. Cl. CPC G06Q 10/063112; G06V 20/52; G10L 15/26

(57) ABSTRACT

In an aspect, a computer-implemented method performed at a server is described. The method may include: receiving, at the server and from a remote computing device, video data defining a video purporting to include at least one scene of a work environment for a project to be performed at a physical location; obtaining project definition data defining one or more parameters of the project; generating a project profile based on at least a portion of the video data and at least a portion of the project definition data; matching the project profile to at least one project-seeker account; and generating a notification of the project associated with the project profile on a computing device associated with the matched project-seeker account.

### TECHNICAL FIELD

The present application relates to project profile configuration and distribution systems and methods and, more particularly, to systems and methods for generating a project profile for a project to be performed at a physical location based on video data.

### BACKGROUND

Computer systems and the Internet have made it easier for parties to connect. For example, some computer systems allow service providers to connect with service consumers. In many such systems, a service consumer inputs a text-based description of the service that they want to be performed and this description is distributed to one or more service providers.

While such systems are useful in connecting service providers and service consumers, they suffer from a number of drawbacks. For example, text-based input of data may be time consuming and may allow for input of erroneous, misleading or even fraudulent data. By way of example, in some instances, the service consumers may lack the technical knowledge to properly convey a description of the service. By way of further example, in some instances, the service consumer may misrepresent the scope of the service that is to be performed. In some instances, this may be done inadvertently by the service consumer. In other instances, this may be done intentionally by the service consumer to attempt to have the service performed on better terms than would otherwise be available. In some instances, a party may use such systems to engage in fraud by submitting a fake request for a service on behalf of another person, who may be a real person or a fake person.

Thus, there is a need for improved computer systems for connecting service consumers and service providers that address one or more of the deficiencies in existing systems.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2 is high-level schematic diagram of a computing device;

FIG. 3 shows a simplified organization of software components stored in a memory of the computing device of FIG. 2;

FIG. 4 illustrates, in flowchart form, an example method that may be performed at a server;

FIG. 5 illustrates, in flowchart form, a further example method that may be performed at a server;

FIGS. 6A-6M illustrate example user interface screens provided at a project-defining device; and

FIGS. 7A-7U illustrate example user interface screens provided at a project-seeker device.

Like reference numerals are used in the drawings to denote like elements and features.

### DETAILED DESCRIPTION OF VARIOUS EMBODIMENTS

In an aspect, a computer-implemented method is disclosed. The computer implemented method may be performed at a server. The method may include: receiving, at the server and from a remote computing device, video data defining a video purporting to include at least one scene of a work environment for a project to be performed at a physical location; obtaining project definition data defining one or more parameters of the project; generating a project profile based on at least a portion of the video data and at least a portion of the project definition data; matching the project profile to at least one project-seeker account; and generating a notification of the project associated with the project profile on a computing device associated with the matched project-seeker account.

In some implementations, matching the project profile to the project-seeker account may include matching the project profile based on at least some data extracted from the video data.

In some implementations, obtaining project definition data may include obtaining one or more of the parameters of the project based on the video data.

In some implementations, the notification of the project includes a selectable option to initiate an application for the project.

In some implementations, the method may include receiving application video data defining an application video purporting to include parameters of an application. The application video data may be received at the server and from the computing device associated with the matched project-seeker account. The method may further include generating an application based on at least a portion of the application video data.

In some implementations, obtaining one or more of the parameters of the project based on the video data may include obtaining input from the remote computing device and verifying at least a portion of the obtained input based on the video data.

In some implementations, obtaining one or more of the parameters of the project based on the video data may include obtaining one or more of the parameters based on metadata included in the video data.

In some implementations, obtaining one or more of the parameters of the project based on the video data may include obtaining location data representing the physical location at which the project is to be performed based on a location defined in the metadata included in the video data.

In some implementations, obtaining one or more of the parameters of the project based on the video data may include passing the video data to a speech-to-text module that performs speech recognition to obtain text data and where one or more of the parameters are obtained from the text data.

In some implementations, obtaining one or more of the parameters of the project based on the video data may include passing at least a portion of the text data to a machine learning module trained to identify one or more of the parameters.

In some implementations, the one or more of the parameters obtained from the video data may include one or more of: a time parameter defining one or more timing preferences for the project, a material parameter defining a material to be used in performing the project, a tool parameter defining a tool to be used in performing the project, a size parameter for the project, and a location parameter defining a location at which the project is to be performed.

In some implementations, obtaining the one or more parameters of the project based on the video data may include performing an automated image analysis of one or more frames of the video.

In some implementations, performing an automated image analysis of one or more frames of the video may include passing at least a portion of the video to a machine learning module trained to identify the one or more parameters.

In some implementations, performing an automated image analysis of one or more frames of the video may include determining one or more size parameters of the project based on the one or more frames of the video.

In some implementations, obtaining the one or more parameters of the project based on the video data may include identifying a quantum of a material to be used in performing the project based on the one or more size parameters.

In some implementations, the notification may include a selectable option to output the video on the computing device. The method further may further include: receiving, at the server, an indication of selection of the selectable option to output the video on the computing device; and in response to receiving the indication of selection of the selectable option to output the video on the computing device, serving at least a portion of the video to the computing device for output thereon.

In some implementations, the method may further include: comparing one or more of the parameters of the project to a representation of related parameters of one or more other projects of a same category; and selectively generating a notification at the remote computing device based on the result of the comparing.

In some implementations, the video data is second video data. The method may further include: receiving, at the server and from the remote computing device, first video data defining a first video purporting to include at least one scene of the work environment for the project to be performed at the physical location; determining, based on the first video data and a threshold length parameter, that the first video is too long; and in response to determining that the first video is too long, generating a notification at the remote computing device.

In another aspect, a server is described. The server may include a communications system. The server may include a memory. The server may include a processor. The processor may be coupled to the communications system and the memory. The memory may have stored thereon processor-executable instructions which, when executed, configure the processor to cause the server to perform a method described herein. For example, in one implementation, the processor-executable instructions may configure the server to: receive, from a remote computing device, video data defining a video purporting to include at least one scene of a work environment for a project to be performed at a physical location; obtain project definition data defining one or more parameters of the project; generate a project profile based on at least a portion of the video data and at least a portion of the project definition data; match the project profile to at least one project-seeker account; and generate a notification of the project associated with the project profile on a computing device associated with the matched project-seeker account.

In yet another aspect, a non-transitory computer-readable storage medium is provided. The non-transitory computer-readable storage medium includes computer-executable instructions which, when executed, configure a server to perform a method described herein. For example, in some implementations, the computer-executable instructions configure the server to: receive, from a remote computing device, video data defining a video purporting to include at least one scene of a work environment for a project to be performed at a physical location; obtain project definition data defining one or more parameters of the project; generate a project profile based on at least a portion of the video data and at least a portion of the project definition data; match the project profile to at least one project-seeker account; and generate a notification of the project associated with the project profile on a computing device associated with the matched project-seeker account.

In another aspect, a computer-readable storage medium may be provided. The computer-readable storage medium may include computer-executable instructions which, when executed, configure a computer, such as a server, to perform a method described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

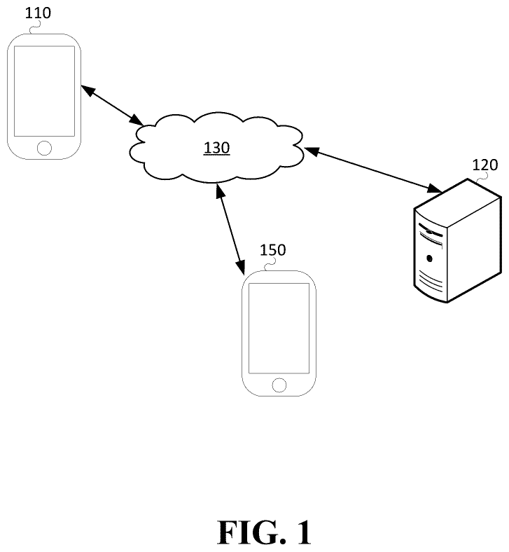

FIG. 1 is a schematic operation diagram illustrating an operating environment of an example embodiment. The operating environment includes a project-defining device 110. The project-defining device 110 may, additionally or alternatively, be referred to as one or more of a computing device, a remote computing device (since it is situated remote from a server), a customer device, an electronic device, a communication device, a computing system and customer equipment.

The project-defining device 110 is a device that is associated with an entity that defines a project that is to be performed at a physical location. This entity may be referred to as a project-defining entity or a customer or a service consumer. The physical location may be a particular location. That is, the physical location may be a location that is defined. The physical location may be a geolocation. The physical location may include or be represented by or associated with particular geographic coordinates such as a latitude and longitude and/or an address.

The project-defining entity may be desirous of having a project performed at a property. By way of example, the project-defining entity may be a homeowner or renter that is desirous of having a project performed at a home. By way of further example, the project-defining entity may be a business or business owner that is desirous of having a project performed at a place of business. By way of further example, the project-defining entity may be a land-owner or land-leaser that is desirous of having a project performed at a particular site. By way of yet a further example, the project-defining entity may be a property manager that is desirous of having a project performed at a property being managed. The project-defining entity may be of other types.

The project may, in at least some implementations, be one or more of a maintenance project, a repair project, an installation project, a renovation project, a remediation project, a cleaning project, a debris or waste removal project, a destruction project or an improvement project. By way of example, the project may involve a maintenance, repair, installation, renovation, remediation, cleaning, debris or waste removal, destruction or improvement to a building, such as a home. By way of further example, the project may involve repairing one or more physical household objects or physical objects located at a place of business. Example projects may include one or more of the following projects services: interior cleaning, exterior cleaning, plumbing, electrical, heating, air conditioning, gas services, ventilation maintenance, duct cleaning, appliance installation, appliance repairs, appliance maintenance, floor repairs, ceiling repairs, wall repairs, blind installations, window treatments, electronics repairs, electronics installations, smart home network troubleshooting, home internet network maintenance, equipment installations, equipment repairs, equipment maintenance, mounting, furniture assembly, painting, relocating heavy household objects, caulking, carpet and upholstery cleaning, garage door repairs, locksmith services, mould remediation, power washing, roofing, tree services, frame installations, frame repairs, door installations, door repairs, sauna repairs, carpentry, demolition services, junk and debris removal, outdoor cooking equipment maintenance and repairs, deck repairs, fence repairs, pool cleaning and maintenance, hot tub cleaning and maintenance, cavestrough repairs, cavestrough cleaning, yard work, landscaping, gardening services, lawn maintenance, artificial turf installation, snow removal, leaf collection, asphalt maintenance and resurfacing, driveway repairs, or a project of another type.

The project may, additionally or alternatively, be referred to as one or more of a task, a job, a contract, a repair, a fix, a service and/or work.

The project-defining device 110 may be associated with an account at a server 120. The account may be referred to as a customer account or a project-defining account or a poster account. The account may be a logical storage area or may include a logical storage area. The account may include account data. The account data may include, for example, a project profile. The project profile may be of a type described herein. For example, the project profile may be generated, at least in part, based on video data. The video data may be data obtained from the project-defining device 110. For example, the project-defining device 110 may include a camera which may generate the video data. Such camera may, for example, be part of a mobile device or a tablet computer or a wearable computer such as smart glasses. The account data may, additionally or alternatively, include other types of data. By way of example, the account data may include one or more of: profile data for the project-defining entity such as a name, address, geolocation data, contact data such as a messaging address and/or telephone number, username data defining a username linked to the project-defining entity account, rating or review data indicating one or more ratings and/or reviews defined by project-performing entities (who may be referred to as project-seeking entities) associated with completed projects, project data for one or more projects that have been completed for the project-defining entity, project data for one or more projects that the project-defining entity has scheduled for completion with a project-seeking entity, application data defining one or more applications for one or more projects that the project-defining entity has posted, or other data.

The operating environment also includes a project-seeker device 150. The project-seeker device 150 may, additionally or alternatively, be referred to as one or more of a computing device, a service provider device, a remote computing device (since it is situated remote from a server), a bidder device, a computing device, a project-performer device, an electronic device, a communication device, a computing system and bidder or performer equipment.

The project-seeker device 150 is a device that is associated with an entity that performs or seeks to perform projects. The projects may be of the type described herein. For example, the projects may be projects that are to be performed at a physical location.

The entity that performs or seeks to perform projects may be referred to as a project-seeker or a project-seeking entity or a service provider. The project-seeking entity may be of various types. By way of example, the project-seeking entity may be any one or more of a skilled tradesperson, plumber, electrician, general labourer, cleaner, snow remover, installer, assembler, interior mover, remediator, locksmith, roofer, arborist, gardener, lawn maintenance provider, landscaper, carpenter, painter, drywaller, heating, ventilation and air conditioning tradesperson (also known sometimes referred to as an “HVAC” specialist), or an entity of another type.

The project-seeker device 150 may be associated with an account at a server 120. The account may be referred to as a project-seeker account or a bidder account or a service provider account or a project-performer account. The account may be a logical storage area or may include a logical storage area. The account may include account data. The account data may include data of various types. By way of example, the account data may include one or more of: profile data for the project-seeking entity, such as a name, address, geolocation data, contact data such as a messaging address and/or telephone number, username data defining a username linked to the project-seeker account, credentials of the project-seeker, skills of the project-seeker, rating or review data indicating one or more ratings and/or reviews defined by project-defining entities associated with completed projects, availability data indicating one or more time periods when the project-seeker is or is not available to perform projects, project data for one or more projects that the project-seeker has completed, project data for one or more projects that the project-seeker is scheduled to complete, offer data for one or more projects that the project-seeker has offered to complete, or other data.

The project-defining device 110 and the project-seeker device 150 may be of various types. By way of example, one or both of the project-defining device 110 and the project-seeker device 150 may be one or more of: a mobile device, a tablet computer, a laptop computer, a wearable computer such as a smart watch or smart glasses, or a computing device of another type.

The project-defining device 110 and the project-seeker device 150 may communicate with a server 120. Such communication may be by way of a network 130.

The server 120 may be configured to perform a method described herein or a variation thereof. The server 120 may, in at least some implementations, be referred to as one or more of a computer system, a matching server, a coordination server, a video-processing server, a notification server and an electronic device.

The server 120 may store or otherwise have access to account data. The account data may be stored locally at the server 120 or it may be stored remotely. By way of example, in some implementations, the server 120 may be connected to or in communication with a data store which may store the account data. The account data may be of a type referred to elsewhere herein. By way of example, the account data may include account data for one or both of the project-defining account and the project-seeker account.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, or the like. Additionally, or alternatively, the network 130 may be or may include one or more payment networks. The network 130 may, in some embodiments, include a plurality of distinct networks. For example, communications between certain of the computer systems may be over a private network whereas communications between other of the computer systems may be over a public network, such as the Internet.

While a single project-defining device 110 and a single project-seeker device 150 are illustrated in FIG. 1, in practice, the server 120 may communication with numerous project-defining devices 110 and project-seeker devices 150.

The server 120 may perform any one of a number of possible operations, some of which are defined herein. By way of example, in at least some implementations, the server 120 may provide data to or receive data from one or more project-defining devices 110 and one or more project-seeker devices 150. By way of further example, in at least some implementations, the server 120 may process video data received from one or more of the project-defining devices 110. By way of yet a further example, in at least some implementations, the server 120 may generate a project profile based on at least a portion of video data received from one or more of the project-defining devices 110. By way of another example, in at least some implementations, the server 120 may match one or more project profiles to one or more project-seeker accounts. In some implementations, the server 120 may provide notification functions. For example, the server 120 may cause a notification to be generated on a project-defining device 110 and/or a project-seeker device 150. At least some other operations and functions performed by the server 120 are as described herein.

The project-defining device 110, project-seeker device 150 and the server 120 may be in geographically disparate locations. Put differently, each of project-defining device 110, project-seeker device 150 and the server 120 may be remote from others of the project-defining device 110, project-seeker device 150 and the server 120.

The project-defining device 110, project-seeker device 150 and the server 120 may each be both a computer system and a computing device.

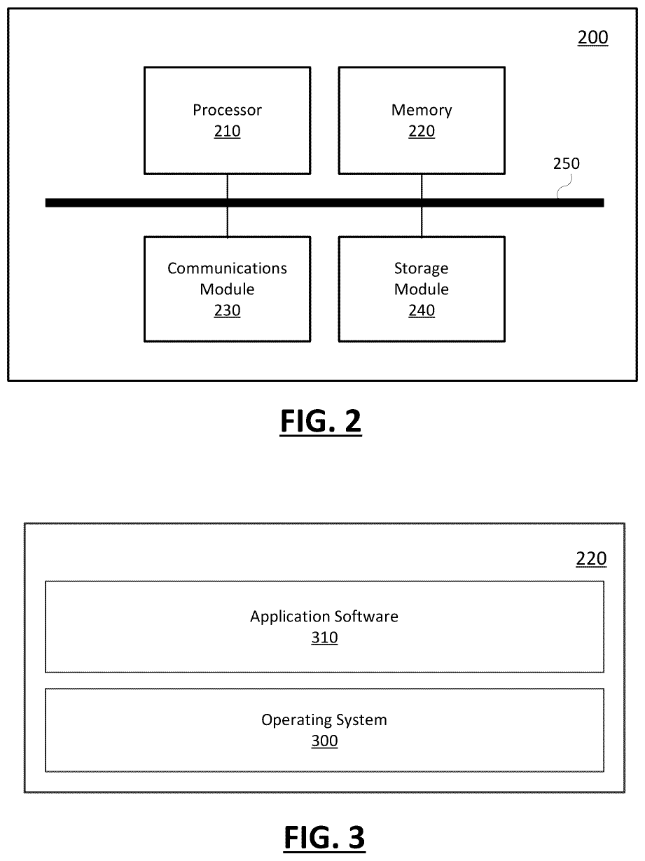

Referring now to FIG. 2, a high-level operation diagram of an example computing device 200 will now be described. The example computing device 200 may be exemplary of the project-defining device 110, project-seeker device 150 and/or the server 120.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors, or the like.

The memory 220 allows data to be stored and retrieved. The memory 220 may include, for example, random access memory, read-only memory, and/or persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), or the like. Additionally, or alternatively, the communications module 230 may allow the example computing device 200 to communicate using near-field communication (NFC), via WiFi™, using Bluetooth™, or via some combination of one or more networks or protocols. In some embodiments, all or a portion of the communications module 230 may be integrated into a component of the example computing device 200. For example, the communications module may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally, or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. For example, the example computing device 200 may rely on cloud storage for at least some data storage. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The computing device 200 will include other components apart from those illustrated in FIG. 2 and the specific component set may differ based on whether the computing device 200 is operating as the project-defining device 110, project-seeker device 150 and/or the server 120. For example, the computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of example, where the computing device 200 is operating as a project-defining device 110, the input modules may include a camera which is used to generate video data. In some implementations, the camera may be a depth-capable camera which may also be referred to as a depth camera. For example, the camera may include multiple cameras. Put differently, the camera may include multiple image sensors. In at least some implementations, the camera may be or include a stereoscopic camera. The depth camera may obtain depth data such as a depth map for image data such as video data or photo data obtained using such cameras. The depth data or depth map may indicate a distance of a portion of an image or video, such as a pixel, to the camera.

In some implementations, the input modules may include other sensors and one or more of these other sensors may be used to obtain depth data or a depth map. For example, in some implementations, the input modules may include a light detection and ranging (LiDAR) sensor. In some implementations, the camera may include a LiDAR sensor.

By way of further example, the computing devices 200 may include one or more output modules, which may be in communication with the processor 210 (e.g., over the bus 250). The output modules may include one or more display modules which may be of various types including, for example, liquid crystal displays (LCD), light emitting diode displays (LED), cathode ray tube (CRT) displays, etc. By way of further example, the output modules may include a speaker.

Where the computing device is operating as the project-defining device 110 and/or project-seeker device 150, the computing device may include a location subsystem. The location subsystem may include, for example, a global positioning system (GPS) module and/or a cellular triangulation module. The location subsystem may obtain a geolocation representing a current location of the computing device.

The input and output modules and communications module are devices and may include, for example, hardware components, circuits and/or chips. The input and output modules may also include some software components. For example, cameras may include both hardware such as a sensor that generates sensor data including an image sensor generating image data and software that processes such data to improve such data and/or make such data more usable for other components.

FIG. 3 depicts a simplified organization of software components stored in the memory 220 of the example computing device 200 (FIG. 2). As illustrated, these software components include an operating system 300 and an application software 310.

The operating system 300 is software. The operating system 300 allows the application software 310 to access the processor 210 (FIG. 2), the memory 220, and the communications module 230 of the example computing device 200 (FIG. 2). The operating system 300 may be, for example, Google™ Android™, Apple™ iOS™, UNIX™, Linux™. Microsoft™ Windows™, Apple OSX™, or the like.

The application software 310 adapts the example computing device 200, in combination with the operating system 300, to operate as a device performing a particular function. For example, the application software 310 may cooperate with the operating system 300 to adapt a suitable embodiment of the example computing device 200 to operate as the project-defining device 110, project-seeker device 150 and/or the server 120.

While a single application software 310 is illustrated in FIG. 3, in operation the memory 220 may include more than one application software 310 and different application software 310 may perform different operations.

Where the example computing device is operating as the project-defining device 110. the application software 310 may be or include a project-defining application. The project-defining application may configure the project-defining device 110 to interact with the server 120. For example, the project-defining application may, together with the server 120 cause the project-defining device 110 to perform operations described herein as being performed on the project-defining device 110. By way of example, the project-defining application may cause the project-defining device 110 to obtain video data defining a video purporting to include a scene of a work environment for a project that is to be performed at a physical location. The project-defining application may be a stand-alone and/or special-purpose application such as an app. In some implementations, the project-defining application may be or include a web browser. For example, the web browser may allow the project-defining device 110 to interact with the server 120 and the server 120 may serve a web-based interface to the web browser.

Where the example computing device is operating as the project-seeker device 150, the application software 310 may be or include a project-seeker application. The project-seeker application may configure the project-seeker device 150 to interact with the server 120. For example, the project-seeker application may, together with the server 120, cause the project-seeker device 150 to perform operations described herein as being performed on the project-seeker device 150. By way of example, the project-seeker application may cause the project-seeker device 150 to output one or more notifications. The project-seeker application may be a stand-alone and/or special-purpose application such as an app. In some implementations, the project-seeker application may be or include a web browser. For example, the web browser may allow the project-seeker device 150 to interact with the server 120 and the server 120 may serve a web-based interface to the web browser.

In some implementations, the project-seeker application and the project-defining application may be a common application. For example, a single application may operate in different operating modes. One of the operating modes may be for project-seekers and another may be for project-defining entity.

Where the example computing device is operating as the server 120, the application software 310 may include one or more software applications or modules. By way of example, in at least some implementations, one or more software modules may include a speech-to-text module. The speech-to-text module may be configured to perform speech recognition to obtain text data from video data and/or other audible data. For example, the audio portion of the video may be analyzed by the speech-to-text module to identify and extract the text contained therein. The speech-to-text module may identify one or more words and/or sentences spoken in the video. The text may be stored in a text format. For example, a text file may be generated and, in at least some implementations, saved by the speech-to-text module. The speech-to-text module may also be referred to as a speech recognition module. In some implementations, the speech-to-text module may be a software module residing in memory of the server 120 and in other implementations, it may reside elsewhere. For example, the speech-to-text module may be a cloud-based service. In some implementations, the speech-to-text module may be accessible by the server 120 via an application programming interface (API). By way of example, in some implementations, the server 120 may upload video and/or audio data to another server that stores the speech-to-text module and it may receive back a representation of the text contained in the video and/or audio data. The output of the speech-to-text module may, in at least some implementations, be or include ASCII (American Standard Code for Information Interchange) data.

Where the example computing device is operating as the server 120, the software modules may include one or more machine learning modules. A machine learning module may be or include an artificial intelligence module, a classifier and/or a large language module (LLM). The machine learning module may be trained to process image, video, audio and/or text data. In at least some implementations, the machine learning module may be configured to aid in identifying or otherwise obtaining one or more parameters that are defined in project definition data for a project. For example, the machine learning module may be configured to identify one or more of: a category parameter defining a category of the project, a time parameter defining one or more timing preferences for the project such as a date when the project is to be performed or a time limit for performance of the project, a material parameter defining a material to be used in performing the project, a tool parameter defining one or more tools to be used in performing the project, a location parameter defining a location at which the project is to be performed, or a size parameter for the project defining measurements and/or dimensions of a work environment, or an object within the work environment, at which the project is to be performed. By way of example, measurements and/or dimensions may be obtained based on LiDAR data and/or based on a depth map. In at least some implementations, at least one parameter may be identified or obtained from text data obtained from a text-to-speech module. For example, the spoken words in a video may be converted to text and passed to the machine learning module which may be configured to detect the at least one parameter.

In some implementations, the machine learning module may be a software module residing in memory of the server 120 and in other implementations, it may reside elsewhere. For example, the machine learning module may be a cloud-based service. In some implementations, the machine learning module may be accessible by the server 120 via an application programming interface (API). By way of example, in some implementations, the server 120 may upload video and/or image and/or audio data and/or text data to another server that stores the machine learning module and it may receive back an output. In some implementations, the server 120 may submit a query or instructions to the machine learning module and the output may be based on the query or instructions. The instructions may indicate one or more parameters that the machine learning module is to identify based on the video, image, audio or text data.

The machine learning module may be trained using supervised, unsupervised and/or reinforcement learning techniques or a combination thereof. In some implementations, the machine learning module may be trained with a training set. For example, a sample set of video, image, audio and/or text data may be used to train the machine learning module. Each sample in the sample set may be tagged with features that are to be associated with that sample.

The machine learning module may, in at least some implementations, be or include a neural network.

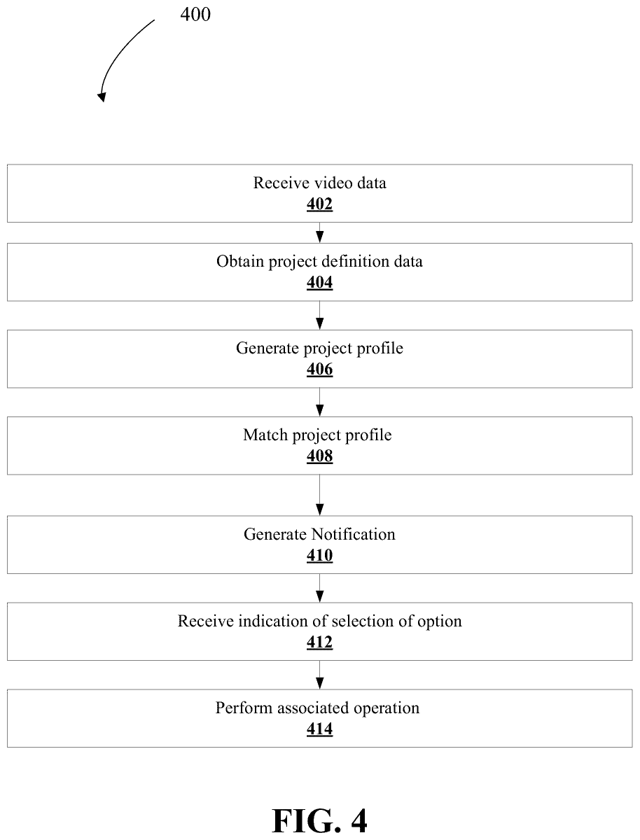

Reference is now made to FIG. 4, which shows, in flowchart form, an example method 400 that may be performed by a server 120.

Operations starting with operation 402 and continuing onward are performed by the processor 210 of a computing device 200 executing software comprising instructions such as may be stored in the memory 220 of the computing device 200 (FIG. 2). For example, the operations of the method 400 may be performed by the server 120 (FIG. 1). More particularly, processor-executable instructions and/or computer-executable instructions may, when executed, configure a processor 210 of the server 120 to perform the method 400 or a portion or variation thereof. In some embodiments, the operations of method 400 may be performed by the server 120 in conjunction with one or more other computing systems, such as the project-defining device 110 and/or the project-seeker device 150.

At an operation 402 (FIG. 4), the server 120 may receive data from a remote computing device. For example, the server 120 may receive data from the project-defining device 110 (FIG. 1). The data may include video data. The video data defines a video purporting to include at least one scene of a work environment for a project to be performed at a physical location. The video may be received from the project-defining device 110 as an upload or as capture. In some implementations, the project-defining device 110 may display or otherwise provide access to a selectable option to upload a video that has already been captured and saved in memory of the project-defining device 110 and a user may use this option to initiate an upload of the video data to the server 120. In some implementations, the project-defining device 110 may display or otherwise provide access to a selectable option to capture a video and a user may use this option to capture a video and send the captured video to the server 120.

The video data may be a video or may represent a video. The video may include at least one scene be of a work environment for a project. A scene may be or include a frame of a video. The video may include an audio component in addition to a visual component. The audio component may include the voice or speech of the project defining-entity captured in the video. A work environment is an area or location at which a project is to be performed. By way of example, the work environment may be an area or region associated with a property, such as a home, business or land. Where the project is a maintenance project, the work environment may be a region or area that is being maintained, such as a furnace or appliance or a lawn or garden or a work environment of another type. Where the project is a repair project, the work environment may be an item being repaired. By way of example, the repair may be a repair to drywall and the work environment is the damaged drywall. Where the project is an improvement project, the work environment may illustrate an area or item being improved. By way of example, where the improvement involves mounting or hanging or installing an item, the work environment may include a scene of the area at which the mounting, hanging or installing is to occur and/or it may include a representation of the item being mounted, hung or installed.

The work environment may be at a physical location. That is, the project may be a project that is to be performed at a physical location. The physical location may be a particular location. That is, the physical location may be a location that is defined. The physical location may be or include, for example, particular geographic coordinates such as a latitude and longitude or an address. The address may be, for example, an address of a house, business, property or lot where the project is to be performed. The physical location may be a room or area of a home, business, property or lot where the project is to be performed.

The video data may be received in association with an account. The account may be referred to as a customer account or a service consumer account or a project-defining account or a poster account. A customer may login to the account in order to associate the video data with the account. Such login may involve the input of one or more login credentials. The login credentials may include one or more of a username, password, personal identification number (PIN), token, and/or a biometric such as a fingerprint. In some implementations, the logic credentials may be or include an access token such as an Open Authorization (OAuth) access token. The login credentials may be verified or authenticated in order to associate a particular communication session with a particular account.

Referring to FIG. 1, the video data may be received at the server 120 from the project-defining application. That is, the project-defining application may be used to facilitate the obtaining of the video data by the server 120. The project-defining application may, in at least some implementations, provide a selectable option to upload the video or capture the video and the video data may be sent to the server 120 by the project-defining device 110 and received at the server 120 after activation of such a selectable option. The selectable option to upload the video may configure the project-defining device 110 to select already-captured video data for upload and the selectable option to capture the video may configure the project-defining device 110 to initiate capture of video data for upload.

The project-defining application may cooperate with other software applications or modules on the project-defining device 110 in order to facilitate capture of the video data and/or upload of the video data. By way of example, in some implementations, the project-defining application may engage a camera application or camera module on the project-defining device 110 which may cooperate with a camera to obtain the video data or which may retrieve previously-captured video data from memory.

The video data may be or include data in a standard video format. By way of example, in some implementations, the video data may include data formatted according to a video standard such as a Motion Pictures Experts Group (MPEG) standard, such as MP4. Other video standards may be used such as, for example, MOV (QuickTime Movie), WMV (Windows Media Viewer), AVI (Audio Video Interleave), MPEG-2, or a standard of another type.

The video data may include metadata. The metadata may be data that is automatically applied to and/or associated with the video by the project-defining device 110. The metadata may, for example, define a location. The location may be a location at which the video data was obtained. For example, the location may be a location of the project-defining device 110 when the video was obtained. This location may indicate the physical location associated with the project. That is, this location may indicate or represent the particular location at which the project is to be performed. Put differently, this location may be a location of the work environment.

The location that is included in the metadata may be a location obtained from a location subsystem of the project-defining device 110. The location subsystem may include, for example, a global positioning system (GPS) module and/or a cellular triangulation module. The location in the metadata may include coordinates such as latitude and longitude coordinates and/or may include an address such as a street address. The location may also be referred to as a geolocation.

Other types of metadata may be included in or associated with the video data instead of or in addition to the location. By way of example, in some implementations, the metadata may include a timestamp. The timestamp may include a date and/or a time. The timestamp may also be referred to as a date stamp.

Other types of metadata may be included in or associated with the video data apart from the types specifically highlighted herein.

The metadata may be data that is applied by the device that captured the video data and so it may be referred to in some implementations as device-applied data. That is, the metadata may be automatically applied to the video data by the project-defining device without any specific interaction by the operator or user in order to apply such data. In some implementations, the metadata may be referred to as supplementary or auxiliary data since it supplements the video defined by the video data.

The video data may, in at least some implementations, include depth data, such as a depth map and/or LiDAR data. The LiDAR data may be or include a LiDAR stream. The LiDAR data may be data generated by or from a LiDAR camera. Depth data may include data that indicates depth or from which depth may be determined. The video data, such as the LiDAR data, may include a point cloud or other data that represents or defines dimension data. For example, such data may allow the size of objects contained in the video data or the size of a workspace represented therein to be obtained. For example, such data may allow for determination of a height of an object or workspace and/or a width of an object or workspace.

The video data includes a video purporting to include at least one scene of a work environment for a project to be performed at a physical location. That is, the video may be intended to include such a scene. The project-defining application may prompt the user or operator to capture or upload a video that includes at least one scene of a work environment for a project to be performed at a physical location.

Referring still to FIG. 4, at an operation 404, the server 120 (FIG. 1) may obtain project definition data. The project definition data may define one or more project parameters. Project parameters may also be referred to herein as parameters for a project or parameters. The project parameters may include, for example, one or more of: a category of the project, a description of the project, a title of the project, a time parameter for the project, a material parameter for the project, a desired attribute of the project-seeker to perform the project, a tool to be used in performing the project, a value parameter indicating, for example, a desired price that will be paid in exchange for completion of the project, a size parameter for the project, and/or a location parameter indicating a location at which the project is to be performed. The parameters of the project may include other data apart from the parameters defined above.

As noted above, the project definition data may include a category of the project. The category of the project may be, for example, a project type. Example categories may include any one or a combination of an electrical project, a plumbing project, a painting project, a roofing project, a landscaping project, an HVAC project, or a project of another type.

As noted above, the project definition data may include a description of the project. The description of the project may be a text-based description of the project. The description of the project may be a summary of the project. The description of the project may, in some implementations, be a short summary of the project. A short summary of the project may mean that the description of the project is a limited-length description. The description may be limited to a defined number of characters, words, lines or sentences. In some implementations, the maximum length of the description may depend on the category. That is, different categories of projects may have different maximum lengths.

As noted above, the project definition data may include a title of the project. The title of the project may be or include a text-based title of the project. The text-based title of the project may be a heading that describes the project at a very high level.

As noted above, the project definition data may include a time parameter for the project. The time parameter may be a desired date when or by which the project is to be completed. The date may be, for example, a particular calendar date. In at least some implementations, the date may represent a project initiation date. In some implementations, the date may represent a project completion date. In some instances, the time parameter may be a desired maximum time limit for the time required or allotted by the project-seeking entity to perform the project.

As noted above, the project definition data may include a material parameter for the project. The material parameter may be the material to be used in performing the project. The project definition data may include a bill of materials or a materials list or a shopping or packing list indicating a plurality of materials that are required to perform the project. The material data may, in some implementations, indicate the level of quality of materials desired to be used by the project-seeking entity to perform the project. In some instances, this list may indicate whether one or more materials are to be provided by the project-defining entity or the project seeking entity.

As noted above, the project definition data may include a desired or required attribute of the project-seeking entity. Example attributes may include the skills, qualifications, credentials, licenses, experience, accreditations, certifications, insurance, criminal background report status, and/or education of the project-seeking entity to perform the project.

As noted above, the project definition data may define one or more tools that are required to perform the project. By way of example, the tool data may indicate a power tool, hand tool or lawn tool that may be required for completion of the project. The tool data may, in some implementations, indicate tools that are to be provided by the project-seeking entity. In some implementations, the tool data may include tools that will be provided by the project-defining entity.

As noted above, the project definition data may include a value parameter for the project. The value parameter may indicate a desired price that will be paid in exchange for completion of the project. The value parameter may indicate an amount of fiat currency and/or cryptocurrency that will be paid.

As noted above, the project definition data may include a size parameter for the project. The size parameter may indicate a size of the project. The size may be a size of an area or region that is to be repaired or maintained. For example, the size may be the size of a work environment. By way of example, where the project represents a lawn maintenance project, the size may be a size of a yard or a portion of a yard that is to be maintained. For example, the size may be expressed in square units such as square meters or square feet. In some instances, the size may be expressed as linear dimensions, a diameter, radius, perimeter, two-dimensional area or three-dimensional area. For example, in one scenario, the project may represent a repair of a hole in drywall and the size parameter may indicate the size of the hole. The size parameter may, for example, be for a size or dimension of a work environment or an object located within a work environment.

As noted above, the project definition data may include a location for the project. The location may be a location at which the project is to be performed. The location may be a physical location. For example, the location may be a geolocation. In some implementations, the location may be or include coordinates. For example, the location may be or include latitude and longitude coordinates. In some implementations, the location may be or include an address such as a street address.

The project definition data may include other parameters instead or in addition to the parameters noted herein. Further, at least some implementations may exclude some of the parameters defined herein. By way of example, some implementations may operate as a bid model in which the project-defining entity does not define a value indicator. Instead, prospective project-seekers may submit applications which define a value indicator. By way of further example, in some implementations, the project-seeker may not define a date. Instead, the availability of prospective project-seekers may be exposed to the project-defining entity as part of the bid submission and review process.

One or more of the project parameters may be obtained by the server 120 (FIG. 1) based on input received at the project-defining device 110 via an input module provided on the project-defining device 110. For example, one or more of the parameters may be obtained from user input received at a keyboard such as a physical or virtual keyboard provided on the project-defining device 110. One or more of the parameters may be obtained based on touchscreen or pointing device input received at the project-defining device 110. For example, one or more categories may be displayed on a display of the project-defining device 110 and an applicable category may be selected.

In at least some implementations, one or more of the project parameters may be obtained based on the video data. The project parameters may be obtained based on the video data in various ways. For example, in at least some implementations, one or more of the project parameters may be obtained based on metadata included in the video data. By way of example, obtaining one or more of the project parameters of the project based on the video data may include obtaining location data representing the physical location at which the project is to be performed based on a location defined in the metadata included in the video data. In this way, the location of the project may be determined by the server 120 based on the location defined in the metadata defined in the video data. Conveniently, by using the location in the metadata to define the project location, fraudulent or erroneously input of a location may be avoided or reduced. In other embodiments, the project parameters may be included in the audio portion of the video data, for example, in the speech or words of a project-defining entity's voice captured within a video.

In some implementations, at least one of the parameters in the project definition data may be determined by the server 120 based on both data input by a user at the project-defining device 110 and also based on metadata. For example, the metadata may be used to verify the data input by the user. That is, the server 120 may obtain one or more of the parameters of the project based on the video data by obtaining input from the remote computing device and verifying at least a portion of the obtained input based on the video data. In the example of a parameter that represents a location where the project is to be performed, the server 120 may verify that the location input by the user corresponds to the location defined in the metadata. This verification may require that the locations be within a defined proximity of one another. If the locations sufficiently correspond then, in at least some implementations, the server 120 may include the user-input location in the project definition data. If, however, the locations do not correspond then the server 120 may perform an error procedure. For example, the server 120 may cause the project-defining device 110 to output an error message. The error message may indicate that the project will not be accepted and/or posted. Accordingly, in at least some implementations, subsequent operations of the method 400 (FIG. 4) may not be performed if the locations do not correspond.

In at least some implementations, one or more of the project parameters in the project definition data may be determined from a software analysis performed on the video itself or a portion of the video. By way of example, in some implementations, obtaining one or more of the parameters of the project based on the video data may include passing the video data to a speech-to-text module. The speech-to-text module may be a module of the type described above. For example, the speech-to-text module may perform speech recognition to obtain text data. Then, one or more of the parameters may be obtained from the text data. Obtaining the parameters from the text data may include a keyword analysis, in at least some implementations. By way of example, a particular keyword spoken in the video, or set of keywords, or key phrases may be interpreted by the server 120 as being associated with a particular category of project. By way of example, the terms “sink”, “drain”, “pipe”, etc. may indicate that the project is plumbing related. In some implementations, a keyword may also be used to identify a desired or required attribute of the project-seeking entity. For example, the terms “sink”, “drain”, “pipe”, etc. may indicate that the project-seeking entity is to be a certified plumber.

In other implementations, another type of analysis may be performed by the server instead of or in addition to the keyword mapping. For example, the text data or a portion of the text data obtained from the speech-to-text module may be passed to a machine learning module. The machine learning module may be as described above. For example, the machine learning module may be trained to identify one or more of the parameters. In some implementations, a description of the project may be obtained based on the text output by the speech-to-text module or a portion of such text. For example, the machine learning module may be trained to generate a concise description based on the text. In some implementations, the machine learning module may be configured to generate a title based on the text. In some implementations, the machine learning module may be configured to identify a location of a project from the text. In at least some implementations, the machine learning module may be configured to identify a category of the project based on the text. In at least some implementations, the machine learning module may be configured to identify a date when the project is to be completed, or how long the project should take to perform, based on the text. In at least some implementations, the machine learning module is configured to identify a material to be used in performing the project based on the text. In at least some implementations, the machine learning module may be configured to identify a desired or required attribute of the project-seeking entity based on the text. In some implementations, identifying such a desired or required attribute of the project-seeking entity may be performed by identifying a type or category of the project and then determining a desired or required attribute of the project-seeking entity based on mapping data that maps one or more desired or required attribute to one or more type or category of project. For example, a plumbing project may be mapped to a certified plumber in the mapping data. In at least some implementations, the machine learning module may be configured to identify a value parameter based on the text. For example, the video may include audio specifying one or more price parameters such as a range or maximum price that the project-seeking entity is willing to pay in order to have the project performed and the machine learning module may identify this value parameter from the text.

The server 120 (FIG. 1) may pass the text or a portion thereof to one or more other modules prior to or instead of the machine learning module. By way of example, in one implementation, the server 120 may pass the text or a portion thereof to a data cleaning module. The data cleaning module may remove certain text and/or it may convert text into an improved format. By way of example, repeated words may be removed, punctuation may be added, words that add no value such as “um” may be removed, etc.

Accordingly, the server 120 may determine one or more parameters from the video data such as, for example, one or more of: a category parameter defining a category of the project, a time parameter defining one or more timing preferences for the project such as a date when the project is to be performed or a time limit for the performance of the project, a material parameter defining a material to be used in performing the project, a tool parameter defining one or more tools to be used in performing the project, a location parameter defining a location at which the project is to be performed, or a size parameter for the project defining measurements and/or dimensions of a work environment, or an object within the work environment, at which the project is to be performed, a description parameter defining a description of the project, a title parameter defining a title of the project, and an attribute parameter defining an attribute of the project-seeking entity.

In some implementations, one or more parameters may be obtained by the server 120 by performing an automated image analysis on one or more frames of the video. The automated image analysis may be performed, for example, by passing at least a portion of the video to a machine learning module that is trained to identify the one or more parameters.

In some implementations, the server 120 may, in performing the automated image analysis, determine one or more size parameters of the project based on the one or more frames of the video. A size parameter may, in some implementations, be a surface area, radial dimension, or linear dimension. By way of example, the automated image analysis may determine a size of a work environment or an object within the work environment. The automated image analysis may identify the portion of the one or more frames of the video that represent the work space, work environment and/or object in the work environment. This may be identified, for example, based on the category of the project. For example, where the category is lawn maintenance, the automated image analysis may identify the portion of the frame(s) that represent the lawn. Or, where the category is a drywall repair, the automated image analysis may identify the portion of the frame(s) that represent the area of the drywall requiring repair. The system may then determine the size of the work space or work environment using, for example, the depth data, LiDAR data, and/or dimension data.

In some implementations, the server 120 may rely on other techniques to determine a size parameter for certain types of projects. For example, a size parameter may be obtained using satellite imagery data for certain types of projects. For example, the server 120 may obtain satellite imagery data corresponding to the location of the project from, for example, another server. The server 120 may then perform an automated image analysis on the satellite imagery data to determine the size parameter. For example, where the server 120 determines that the project is a lawn maintenance project, the server may determine a size of a lawn from the satellite imagery data. Where the server 120 determines that the project is a roofing project, the server 120 may determine a size of the roof from the satellite imagery data. Where the server 120 determines that the project is a pool servicing project, the server 120 may determine a size of the pool from satellite imagery data. Where the server 120 determines that the project is a gardening project, the server 120 may determine the size of a garden from satellite imagery data. Where the server 120 determines that the project is a driveway maintenance project, the server may determine a size of the project from satellite imagery data. In some instances, where the project involves exterior improvements to an exterior of a house, the server 120 may determine a size parameter, such as the surface area of the house, from the satellite imagery data.

Size parameters may also be obtained, in some implementations, based on data obtained from another server which provides data regarding various properties. For example, another server may store data regarding a floor area of a house or other property and such data may be retrieved in order to determine a size parameter for a project. For example, a project may be a cleaning project and the scope of the project may be indicated by the square footage of the house. In another example, if the server 120 determines that the project involves laying new flooring in a house, the server 120 may obtain the size parameter from the another server which stores data regarding the floor area.

In some implementations, the server 120 may obtain one or more parameters of the project based on the video data by identifying a quantum of a material that is to be used in performing the project. The quantum may be determined based on the one or more size parameters. In some implementations, a type of material may be determined based on the category. For example, where the category is drywall repair, the server 120 may determine that drywall may be required for the repair and it may determine an amount of drywall required based on the one or more size parameters.

After the various parameters are obtained at the operation 404 (FIG. 4), they may be presented to the project-defining entity. That is, the server 120 (FIG. 1) may cause such parameters to be output at the project-defining device. The server 120 may prompt or otherwise allow the project-defining entity to confirm the determined parameters.

In some implementations, one or more of the parameters obtained at the operation 404 may be evaluated by the server 120. For example, the server 120 may compare one or more of the parameters of the project to a representation of related parameters of one or more projects of a same category. By way of example, this could involve comparing a project parameter obtained at the operation 404 to a representation of other project parameters for other similar projects. Where a project parameter is of a type that permits for numerical representation, the representation of other project parameters for other similar projects may be an average or another numerical indicator. The comparing may be based on a threshold. By way of example, the server 120 may determine whether the project parameter differs from the average or other numerical indicator by at least a threshold amount. In some implementations, the server 120 may selectively generate a notification at the project-defining device 110 based on the result of the comparing. For example, when the project parameter differs from the average or other numerical indicator by at least the threshold amount, then the notification may be generated at the project-defining device 110. The notification may indicate that the numerical value associated with the project parameter should be increased or decreased as the case may be. By way of example, the server 120 may determine if a value parameter or time parameter should be increased or decreased and notify accordingly.

Referring still to FIG. 4, at an operation 406 of the method 400, the server 120 (FIG. 1) may generate a project profile. The project profile may be generated based on at least a portion of the video data and at least a portion of the project definition data. For example, the project profile may be generated based on data input by the project-defining entity at an input interface associated with the project-defining device 110 and also based on the video data. The project profile may include the video or a portion of the video and one or more of the project parameters.

The project profile may be stored at the server 120 or at a data store accessible to the server 120.

Referring still to FIG. 4, next, at the operation 408, the server 120 (FIG. 1) may match the project profile to at least one project-seeker account. In at least some implementations, the matching may be performed based on data associated with a project-seeker account. For example, preferences or configuration information may be associated with the project-seeker account and the preferences or configuration information, or a portion of such preferences or configuration information, may be matched with the project profile. For example, the preferences or configuration information may be matched with one or more of the project parameters defined in the project profile at operation 406. By way of example, the preferences or configuration information may define one or more of price data, time data, location data, category data, project-seeker attribute data, materials data, tool data, or data of other types. Such preferences or configuration information may then be used by the server 120 to determine whether a particular project-seeker account matches a particular project profile.

The preferences or configuration information may be predefined. For example, the preferences or configuration information may be defined by a project-seeking entity and stored in association with the project-seeker account for that project-seeking entity.

During the matching at operation 408 (FIG. 4), the server 120 (FIG. 1) may match one or more of the preferences or configuration information with a project profile at operation 406 such as, for example, with the project parameters in the project profile. That is, the server 120 may determine whether the one or more of the preferences or configuration information correspond to the parameters in the project profile. In at least some implementations, a match may be determined to occur if all of the preferences or configuration information correspond to the parameters in the project profile. In some implementations, a match may be determined to occur if one of the preferences or configuration information corresponds to the parameters in the project profile. In some implementations, a match may be determined to occur if a sufficient number of the preferences or configuration information correspond to the parameters in the project profile. In some implementations, a match may be determined to occur based on a score that indicates a degree to which the preferences or configuration information correspond to the parameters of the project profile. The score may be determined using one or more weightings which attribute a greater importance to some parameters than other parameters.

Referring back to FIG. 1, in at least some implementations, the matching may be performed by the server 120 based on one or more search parameters defined by a project-seeking entity and/or by the project-seeker device 150. For example, a project-seeker device 150 may send an indication of one or more search parameters to the server 120 and the server 120 may perform the matching based on the one or more search parameters. The search parameters may define one or more of: price data, time data, location data, category data, project-seeker attribute data, materials data, size data, dimension data, tool data, or data of other types. One or more of the search parameters may be defined based on user input received at the project-seeker device 150. One or more of the search parameters may be defined based on other data, such as sensor or system data, obtained at the project-seeker device 150. For example, location data may be obtained from a location subsystem of the project-seeker device 150.

During the matching, the server 120 may match one or more of the search parameters with a project profile such as, for example, with the project parameters in the project profile. That is, the server 120 may determine whether the one or more of the search parameters correspond to the parameters in the project profile at operation 406. In at least some implementations, a match may be determined to occur if all of the search parameters correspond to the parameters in the project profile. In some implementations, a match may be determined to occur if one of the search parameters corresponds to the parameters in the project profile. In some implementations, a match may be determined to occur if a sufficient number of the search parameters correspond to the parameters in the project profile. In some implementations, a match may be determined based on a score that indicates a degree to which the search parameters correspond to the parameters of the project profile. The score may be determined using one or more weightings which attribute a greater importance to some parameters than other parameters.

In at least some implementations, the matching may be performed by the server 120 based on both search parameters and preferences or configuration information. That is, the matching may rely on some pre-defined preferences or configuration information and some search parameters that are received at the server 120 immediately prior to the matching.

In at least some implementations, the matching at operation 408 (FIG. 4) may be performed in response to a trigger operation performed at the project-seeker device 150. For example, the matching may be performed when an instruction to perform a search is received at the server 120 (FIG. 1) from the project-seeker device 150. In this way, the server 120 may support active searching for projects from a project-seeker device 150.

Additionally or alternatively, the server 120 may support passive matching. Such matching may be performed automatically as a background process at the server 120. That is, the server 120 may monitor for projects that are appropriate for a particular project-seeking entity based on the preferences or configuration information defined in the project-seeker account for that project-seeking entity. Accordingly, the matching at operation 408 may not be performed in response to a trigger operation performed at the project-seeker device 150. Instead, the matching may be performed in response to another trigger operation. This trigger operation may be, for example, generation of a new project profile. For example, as new project profiles are submitted, they may be matched with project-seeker accounts. In some implementations, the trigger operation may be a time-based trigger. For example, the matching may be performed in response to a periodic trigger. For example, a search may be conducted automatically by the server 120 daily, weekly, etc. In some instances, the search may be conducted in response to inactivity on the project-seeker device 150 for at least a threshold period of time. For example, if a project-seeker application has not been used for a threshold period of time or if a search has not been requested by the project-seeker device 150 for at least a threshold period of time, then matching may be automatically performed.

The matching at the operation 408 may be or include, for example, searching or filtering or matching of another type. In some implementations, the matching may include ranking. Such ranking may include selecting a highest-ranked project.

As noted above, the matching may be performed based on one or more of price data, time data, location data, category data, project-seeker attribute data, materials data, tool data, time data, price data or other value data or data of other types.

Location data may be or include one or more of a location of a project-seeker device 150, a location defined in preferences or configuration information for the project-seeker account, and/or an input location. Location data may include a geographic location, which may also be referred to as a geolocation. A location defined in a project profile at operation 406 may be determined to match location data for a project-seeker if the locations are within a threshold proximity to one another. The threshold proximity may be configurable by the project seeking entity. For example, the project seeking entity may define the threshold that is to be used at the project-seeker device 150. Thus, the location data may include a threshold proximity. By way of example, the threshold proximity may be expressed in a number of distance units, such as kilometres, miles, metres or feet.

As noted above, the matching may be performed based on category data. Category data may be or include one or more categories of projects of interest to the project-seeking entity. Example categories may include any one or a combination of an electrical project, a plumbing project, a painting project, a roofing project, a landscaping project, an HVAC project, or a project of another type.

As noted above, the matching may be performed based on project-seeker attribute data. Project-seeker attribute data may define one or more skills, qualifications, credentials, licenses, experience level, accreditations, certifications, insurance, criminal background report status and/or education associated with the project-seeking entity. By way of example, the project-seeker attribute data may be or indicate that a particular project-seeking entity is a licensed plumber, electrician, etc.

As noted above, the matching may be performed based on materials data. The materials data may indicate one or more materials that a project-seeking entity has on hand. By way of example, a project seeking entity may wish to identify projects that would allow that entity to use up leftover materials from a past project. The server 120 may allow the project-seeking entity to define the materials data and it may perform the matching based on such data. In at least some implementations, the materials data may define a type of material available. For example, the materials data may indicate that drywall is available. In at least some implementations, the materials data may define a quantum of material available, which may be referred to as the material quantity. For example, the materials data may indicate that one sheet of drywall is available. The server 120 may perform the matching based on one or more of the type of material(s) available, the quality of material available, and the quantum or material quantity available.

As noted above, the matching may be performed based on tool data. The tool data may indicate one or more tools that a project seeking entity has available. By way of example, a project seeking entity may wish to identify projects that would allow that entity to use owned tools. The server 120 may allow the project-seeking entity to define the tools data and it may perform the matching based on such data.

As noted above, the matching may be performed based on other data instead of or in addition to the types of data specifically defined herein.

In at least some implementations, at the operation 408 (FIG. 4), the server 120 (FIG. 1) may match the project profile generated at operation 406 based on at least some data extracted from the video data. For example, as noted in the description of operation 404 above, the server 120 may obtain one or more of the project parameters in the project profile based on an analysis of the video. When performing the matching at the operation 408, the server may use one or more of those project parameters.

The matching may, in some implementations, be a one-to-one matching in which a single project profile is matched with a single project-seeker account. In some implementations, the matching may be a one-to-many matching. For example, the same project profile may be matched to multiple project-seeker accounts. Similarly, a single project-seeker account may be matched with multiple project profiles. In at least some implementations, the operation 408 may be performed repeatedly. In at least some implementations, when the operation 408 is performed, a project-seeker account may be matched with multiple project profiles.

Referring still to FIG. 4, the server 120 (FIG. 1) may, at operation 410, generate a notification of the project profile matched at the operation 408 at a computing device associated with the matched project-seeker account. That is, a notification may be generated at the project-seeker device 150. The notification may be generated in the form of search results in at least some implementations, such as implementations in which the matching is performed in response to an active search at the project-seeker device 150.

In some implementations, the notification may be provided as an in-app notification. In some implementations, the notification may be provided as an operating system level notification.

The notification may, in some implementations, be pushed to the project-seeker device 150. For example, the notification may be sent from the server 120 based on background monitoring for projects that are appropriate for a particular project-seeking entity based on the preferences or configuration information defined in the project-seeker account for that project-seeking entity. The notification may, in some implementations, be pulled by the project-seeker device 150. For example, the notification may be sent from the server 120 in response to a trigger operation performed at the project-seeker device 150. For example, the matching may be performed when an instruction to perform a search is received at the server 120 (FIG. 1) from the project-seeker device 150.

The notification at operation 410 may indicate a single matched project profile or a plurality of matched project profiles. The notification may include one or more of the project parameters associated with the matched project profile. One or more of the project parameters may be displayed or otherwise output when the notification is output on the project-seeker device 150. One or more of the project parameters may not be displayed immediately with the notification but may, instead, be accessible through activation of the notification. By way of example, the notification may display a title associated with the project and the notification may be selected or activated to display other project parameters, such as a description of the project.

The notification may exclude project profiles that were not matched. That is, the notification may include one or more project profiles that were matched but it is filtered to exclude project profiles that did not match.

The notification may include one or more selectable options that allow the project-seeking entity to interact with the notification. For example, the project-seeking entity may be provided with one or more of the following selectable options: an option to display further parameters defined in a project profile for a project, an option to refine a search, an option to filter a search, an option to initiate and/or submit an application for a project defined by a project profile by, for example, submitting a value parameter such as a bid, and/or an option to output the video on the project-seeker device or on another computing device. As an example, a project-seeking entity's bid may include their estimated time and cost for performing the project.

In at least some implementations, the server 120 (FIG. 1) may, at an operation 412 (FIG. 4), receive, from the project-seeker device 150, an indication of a selection of a selectable option associated with a notification. Then, at an operation 414, the server 120 may perform an associated operation. That is, the server 120 may perform an operation associated with the notification and/or the selectable option that was selected. This operation may be an operation that causes the project-seeker device 150 to be updated, in some implementations.

Referring still to FIG. 4, in one example, at the operation 412, the server 120 (FIG. 1) may receive an indication of a selection of the selectable option to output the video on the project-seeker device 150. In response, at the operation 414, the server 120 may cause the project-seeker device 150 to output the video or a portion thereof. For example, the server 120 may serve at least a portion of the video to the project-seeker device 150. The project-seeker device 150 may display the video or the portion thereof.

In another example, at the operation 412, the server 120 may receive an indication of a selection of a selectable option to output further parameters defined for a particular project profile. In response, at the operation 414, the server 120 may cause the project-seeker device 150 to output the further parameters. For example, the server 120 may send the further parameters to the project-seeker device 150. The project-seeker device 150 may display the further parameters or a portion thereof.

In another example, at the operation 412, the server 120 may receive an indication of a selection of a selectable option to refine a search. The project-seeker device 150 may provide refined search parameters to the server 120 and the server 120 may re-perform or refine the matching based on the refined search parameters. In some implementations, the refining may be a filtering operation. Then, at the operation 414, the server 120 may cause the project-seeker device 150 to output a further notification of the results of the refined search.

In another example, at the operation 412, the server 120 may receive an option to initiate or submit an application for a project defined by a project profile by, for example, submitting a value parameter such as a bid. The project-seeker device 150 may provide one or more value parameters, such as a bid from the project-seeking entity, to the server 120. The server may, in at least some implementations, after receiving such a value parameter, provide a notification to the project-defining device 110 that submitted the project that the value parameter relates to. This notification may be provided immediately or it may be performed later; for example, in response to a detected trigger condition. For example, the notification may be provided when the project-defining device 110 sends a request for any applications submitted by project-seeking entities for open projects.

In some implementations, one or more parameters of the application, such as a value parameter, may be obtained through the capture of video. For example, video may be captured at the project-seeker device and the project-seeker may, in the video, indicate parameters such as an estimated length of time required for completion of the project and/or a value parameter such as a bid that the project-seeker expects a project-seeker to provide to perform and complete the project. The server 120 may perform a similar analysis on the video obtained from the project-seeker device 150 as the analysis performed on the video data obtained from the project-defining device 110 described above with respect to the operation 404. For example, a speech-to-text module and/or a machine-learning module may be engaged.

Accordingly, the method 400 may include receiving application video data (at operation 412) defining an application video purporting to include parameters of an application and generating an application (at operation 414) based on at least a portion of the application video data.

In some implementations, the parameters of the application (which may include a bid) may be received in other ways. For example, one or more of the parameters may be received at the server 120 via a user interface provided by the project-seeking application. For example, the user interface may include one or more interface elements such as text boxes, drop-down boxes, selectable indicators, or other interface elements that allow for receipt of such inputs.

In some implementations, when an application is received from the project-seeker, the server 120 may automatically perform some evaluation on the application. For example, when a parameter, such as a value parameter, is received, that parameter may be evaluated relative to related parameters for other projects. For example, the server 120 may compare one or more of the parameters of the application to a representation of related parameters of one or more projects or applications of a same category. By way of example, this could involve comparing a value parameter received at the operation 412 (such as a bid) to a representation of other value parameters received for that project and/or for other similar projects. The representation of other value parameters may be an average or another numerical indicator. The comparing may be based on a threshold, for example. By way of example, the server 120 may determine whether the value parameter received as part of the application or bid differs from the average or other numerical indicator by at least a threshold amount. In some implementations, the server 120 may selectively generate a notification at the project-seeker device 150 based on the result of the comparing. For example, when the value parameter differs from the average or other numerical indicator by at least the threshold amount, then a notification may be generated at the project-seeker device 150. The notification may indicate that the value should be increased or decreased, as the case may be.

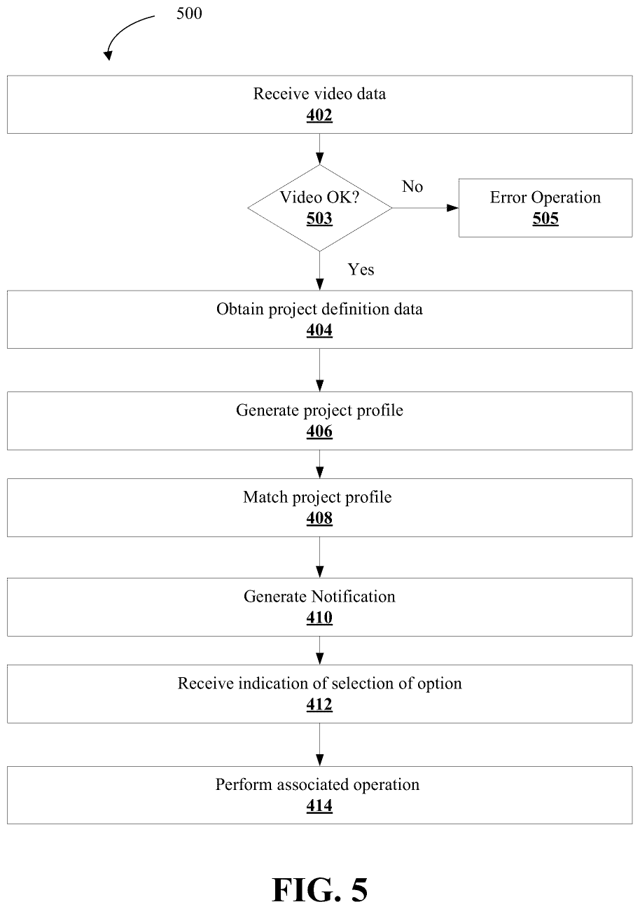

Reference is now made to FIG. 5, which shows, in flowchart form, an example method 500 that may be performed by a server 120 (FIG. 1).

The operations of the method 500 are performed by the processor 210 (FIG. 2) of a computing device 200 executing software comprising instructions such as may be stored in the memory 220 of the computing device 200. For example, the operations of the method 400 may be performed by the server 120. More particularly, processor-executable instructions and/or computer-executable instructions may, when executed, configure a processor 210 of the server 120 to perform the method 500 or a portion or variation thereof. In some embodiments, the operations of method 500 may be performed by the server 120 in conjunction with one or more other computing systems, such as the project-defining device 110 and/or the project-seeker device 150.

The operations of the method 500 of FIG. 5 include many operations in common with the method 400 of FIG. 4 and the description of such operations will not be repeated but like operations have been labelled with like numerals.

At the operation 402, video data may be received at the server 120 as described above with reference to FIG. 4. The video data may be evaluated at an operation 503. In some implementations, the server 120 may evaluate a length of the video. For example, the server 120 may determine, based on the video data and a threshold length parameter, whether the video is too long. The threshold length parameter may be a predefined quantity of time, such as one minute. The threshold length parameter may be category-specific. For example, in some implementations, different project categories may have different threshold length parameters. If the evaluation fails, then the server 120 may perform an error operation 505. By way of example, if the server 120 determines, based on the video data received during an iteration of the operation 402 (which may be referred to as first video data defining a first video) and also based on the threshold length parameter, that the video is too long, then it may perform the error operation 505. The error operation 505 may take different forms. In some implementations, the server 120 may, in performing the error operation 505, generate a notification at the project-defining device 110. The notification may indicate that the video is too long. The notification may provide a selectable option to recapture or re-upload further video data. Another iteration of the operation 402 may then be performed by the server 120. That is, further video data may be obtained.

If the video data, such as the first video data obtained during the first iteration of the operation 402 or the further video data obtained during a subsequent iteration of the operation 402, passes the evaluation operation successfully, then the method 500 may continue with the operation 404 and may proceed to the operation 414 as described above with reference to FIG. 4. The video data may be successfully evaluated by the server 120 if it is determined by the server 120 that the video is not too long.

Other types of evaluation operations may be performed by the server 120 on the video instead of or in addition to evaluating the length of the video. By way of example, the quality of the video may be evaluated. For example, the server 120 may evaluate whether the video is too unsteady at the operation 503 and/or whether the lighting is poor and/or whether the audio is too quiet. In another example, the server 120 may evaluate a date stamp associated with the video. The date stamp may be included in the metadata of the video data. Such an evaluation may ensure that the video was captured recently. Put differently, the date stamp may be used to evaluate freshness of the video. The server 120 may determine that the video is not sufficiently recent if the date stamp indicates that the video was captured more than a threshold period of time prior to a reference time such as a current date and/or time. In some implementations, the evaluation operation performed by the server 120 on the video may be an evaluation of the digital size, such as a file size, of the video. The server 120 may determine that the video is too large (requiring too much storage or memory space) or too small (producing too low quality of a video) relative to threshold file size(s) or an acceptable file size range (based on MB, GB, or the like), thereby triggering error operation 505 based on file size.

In some implementations, the operations 503 and 505 may be performed after the project definition data or a portion of the project definition data is obtained at the operation 404. For example, an iteration of the operation 503 may be performed after a project parameter is obtained at operation 404 to, for example, evaluate that parameter. By way of example, a location that is received via user input at the project-defining device 110 at the operation 404 or that is obtained from a location subsystem of the project-defining device 110 at the operation 404 may be compared with a location obtained from metadata in the video data. The server 120 may verify that the location input by the user or otherwise received via the location subsystem corresponds to the location defined in the metadata. This verification may require that the locations be within a defined proximity of one another. In some implementations, the verification may require that the locations be within a common country or a common region. If the locations do not correspond, then an iteration of the error operation 505 may be performed. Otherwise, the method 500 may continue with the operation 406 where the server 120 generates the project profile or other verification operations may be performed.

The method 400 of FIG. 4 and/or the method 500 of FIG. 5 may include other operations instead of or in addition to the operations illustrated in such figures. By way of example, as noted previously, an application or bid may be submitted by a project-seeking entity in response to a project profile generated at operation 406 for a project-defining account. An indication of that application or bid may be provided to a device associated with the project-defining account. For example, an indication of the application or bid may be provided to the project-defining device 110.

Other operations that may be included in one or more of the methods 400, 500 may be understood from the following discussion of user interface screens that may be displayed on the project-defining device 110 and/or the project-seeker device 150. One or more of the user interface screens or the interface elements displayed thereon may be caused to be displayed by one or more of the project-defining device 110, the project-seeker device 150 and the server 120.

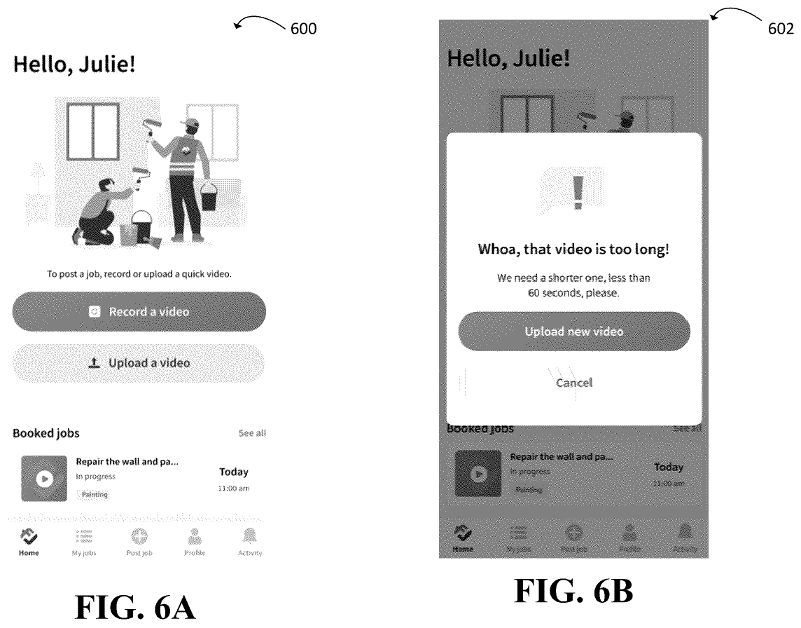

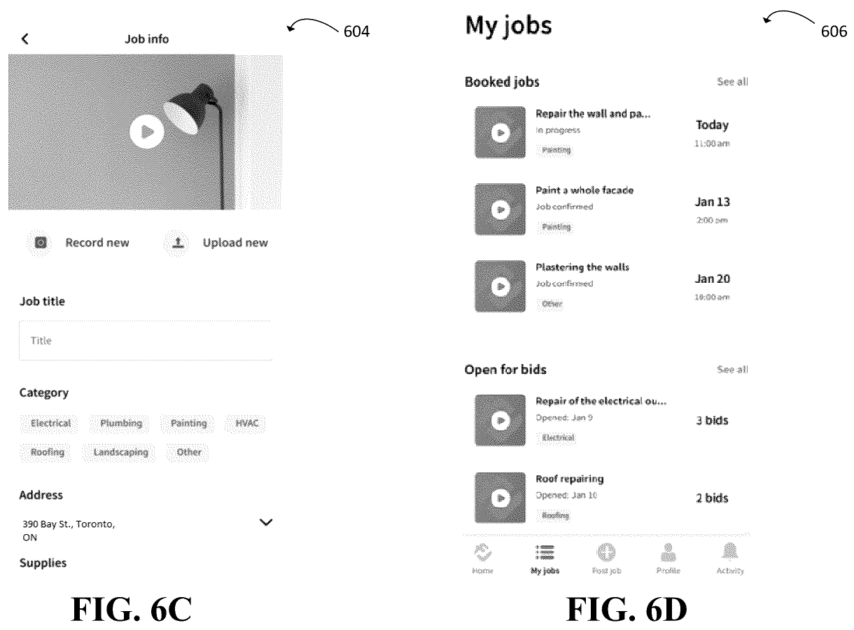

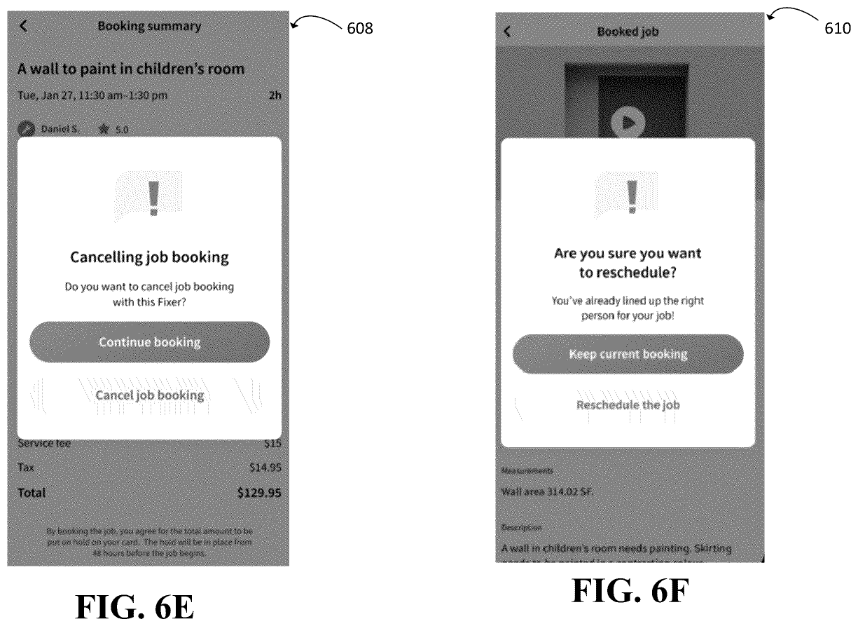

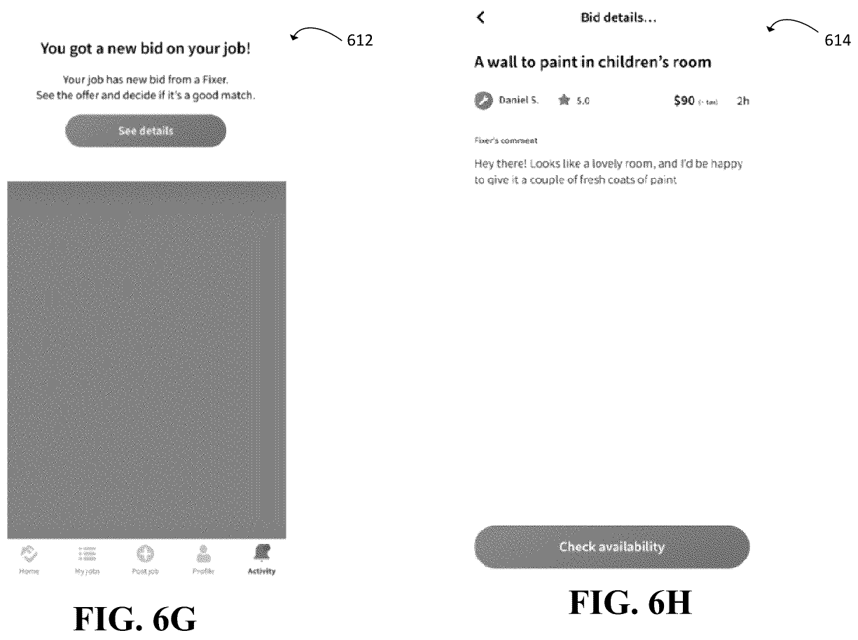

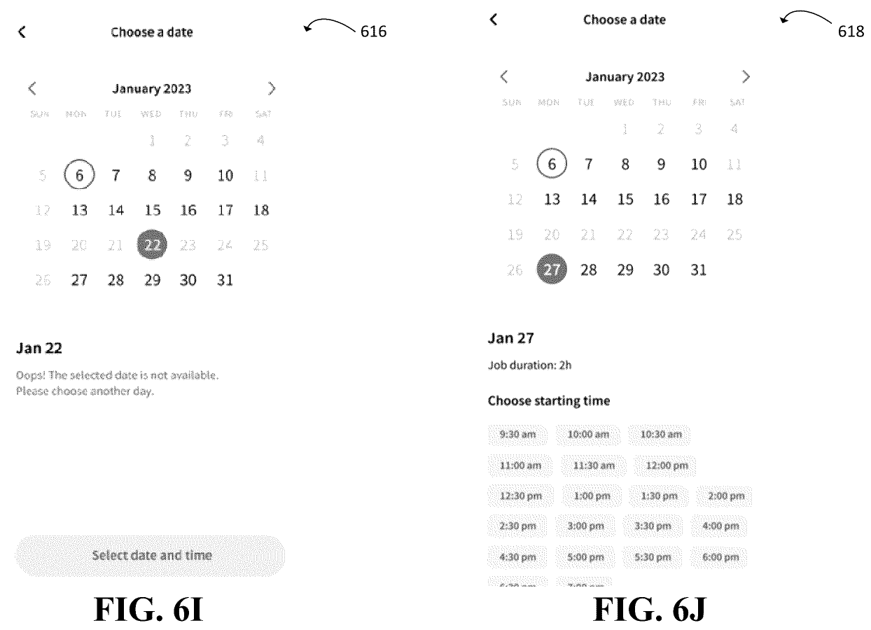

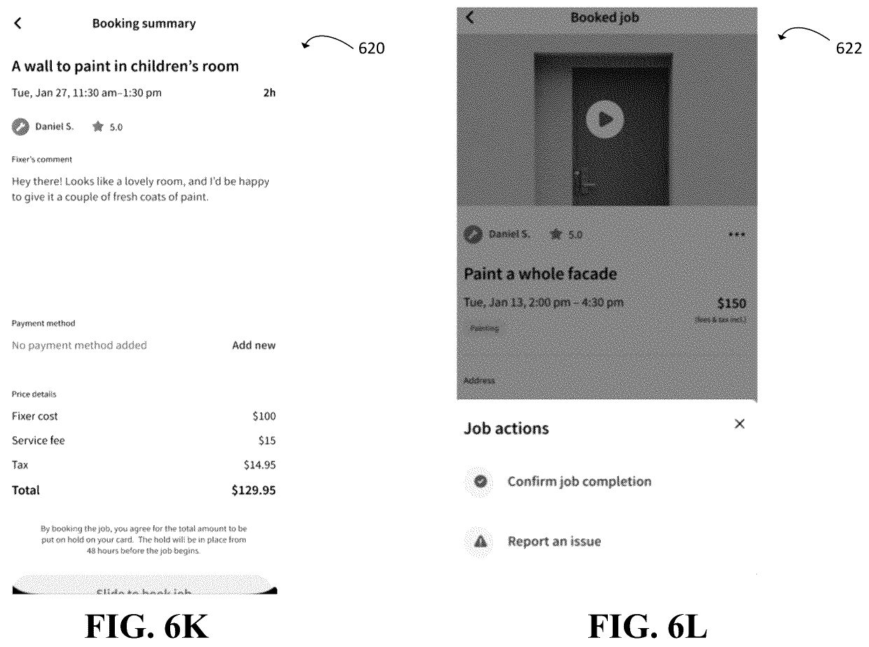

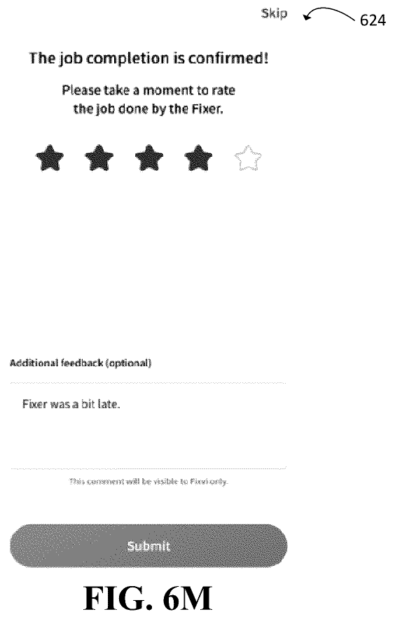

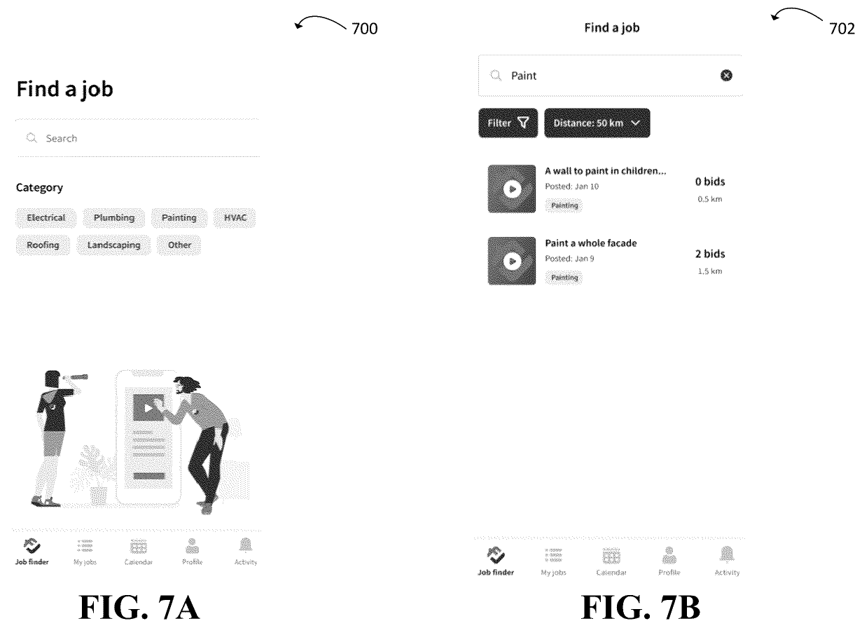

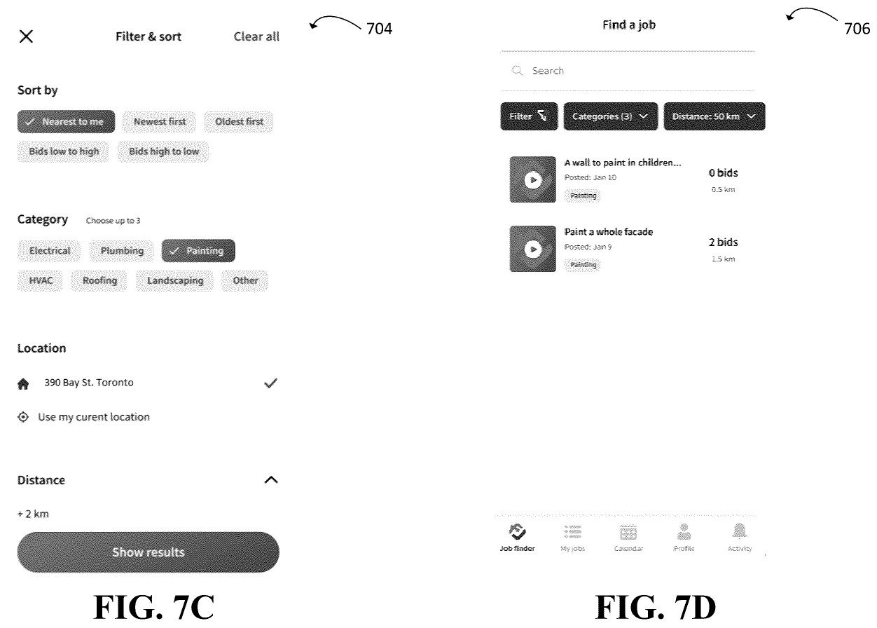

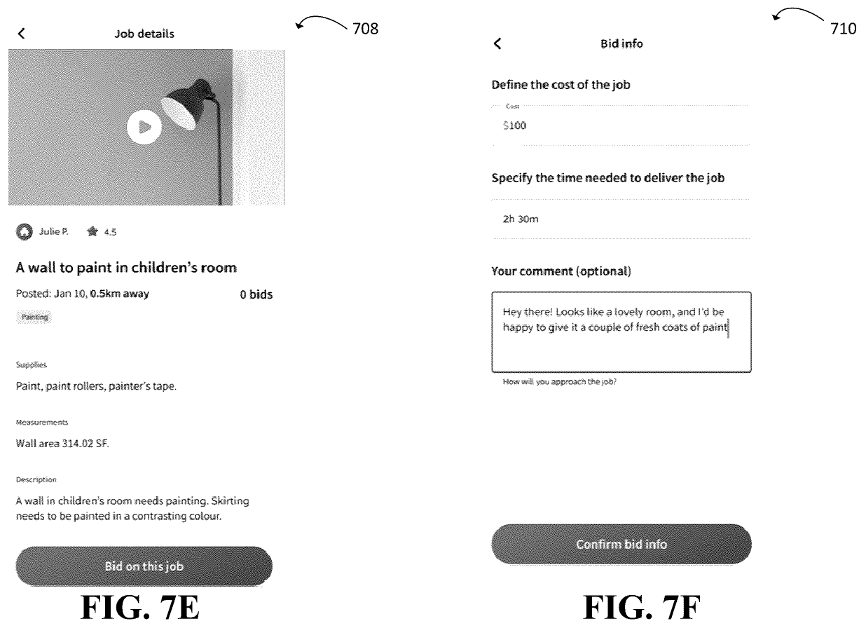

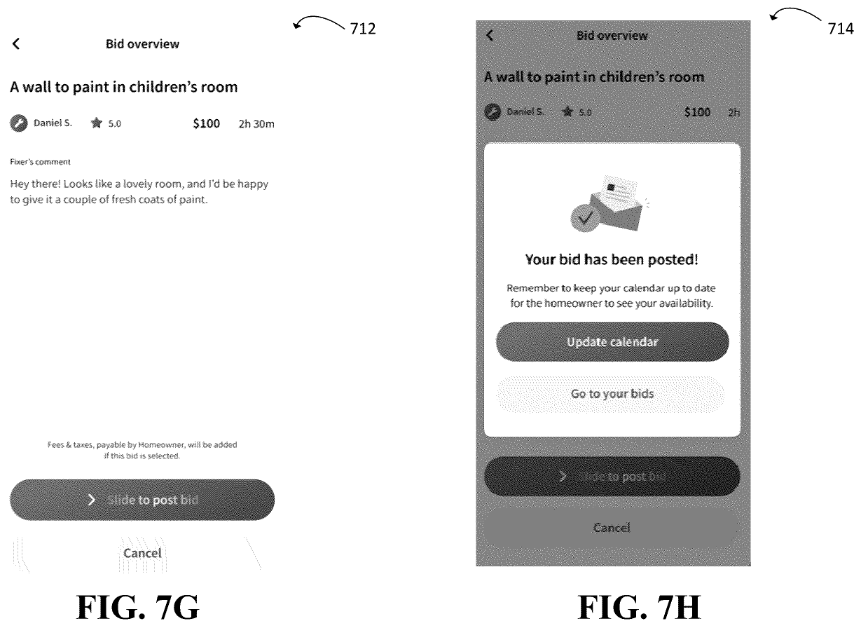

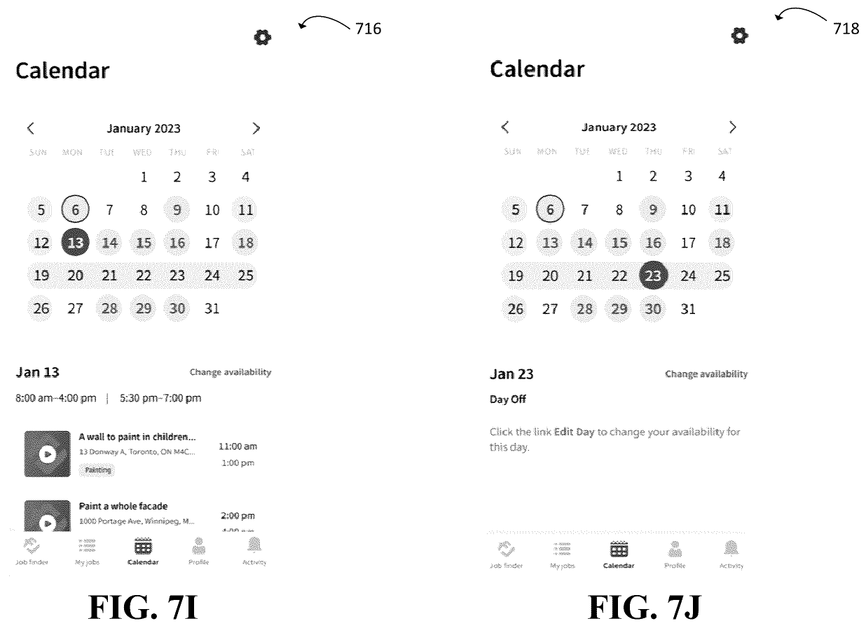

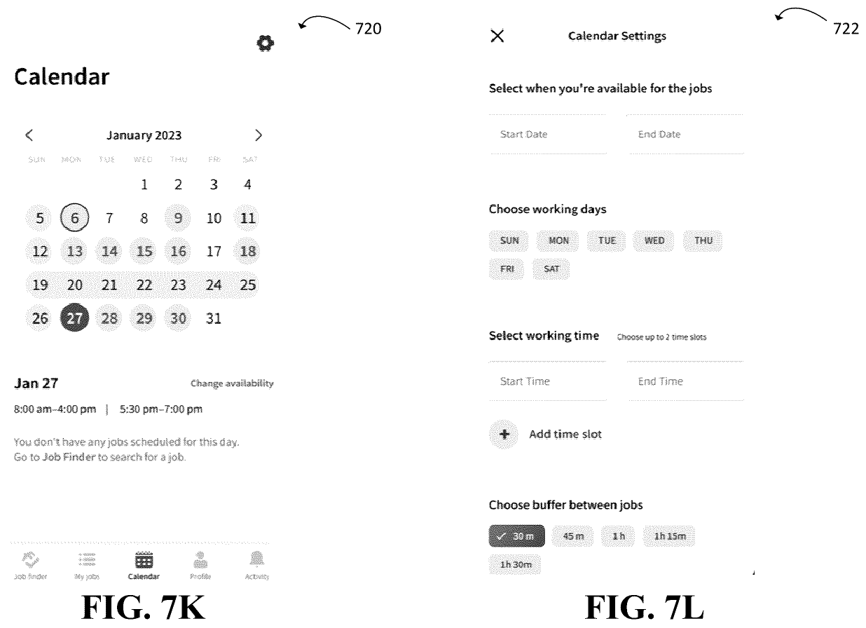

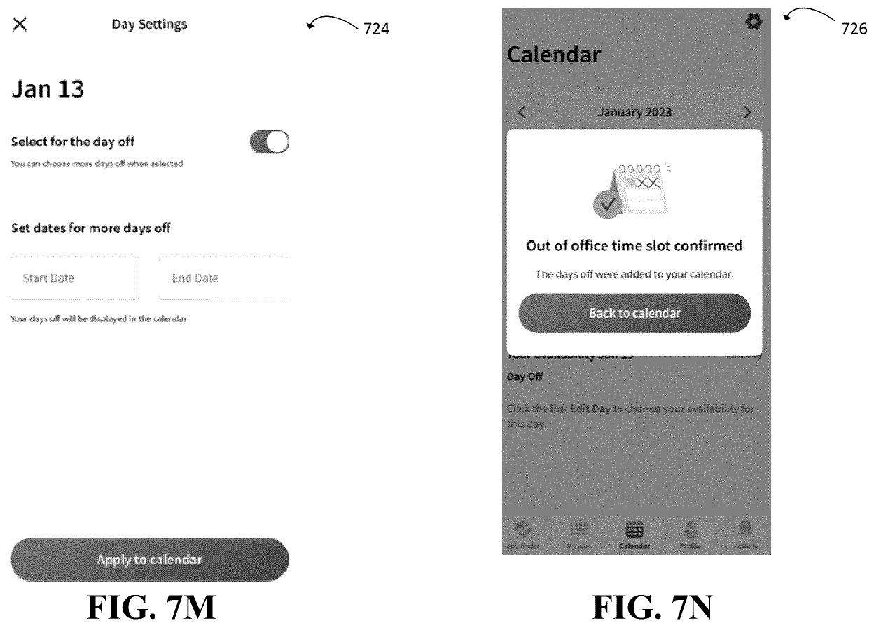

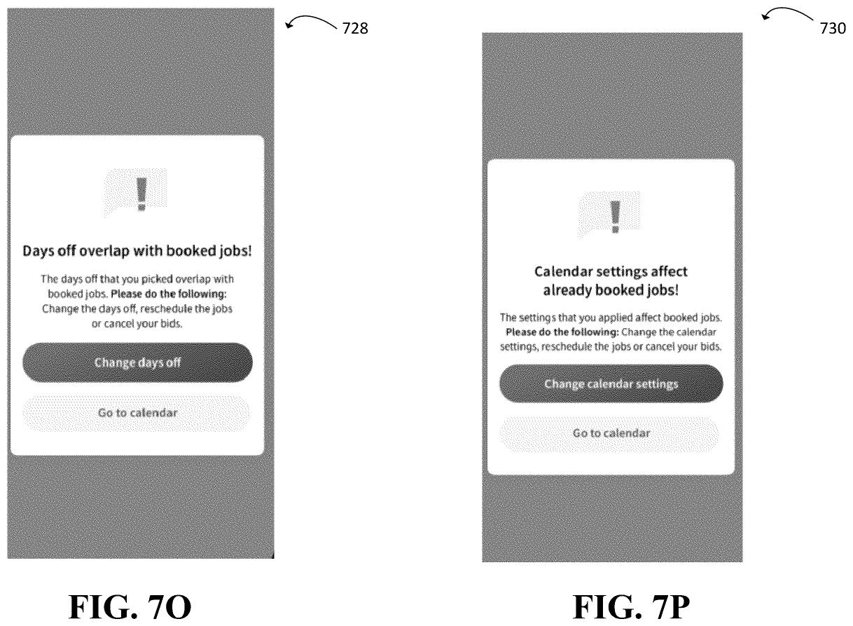

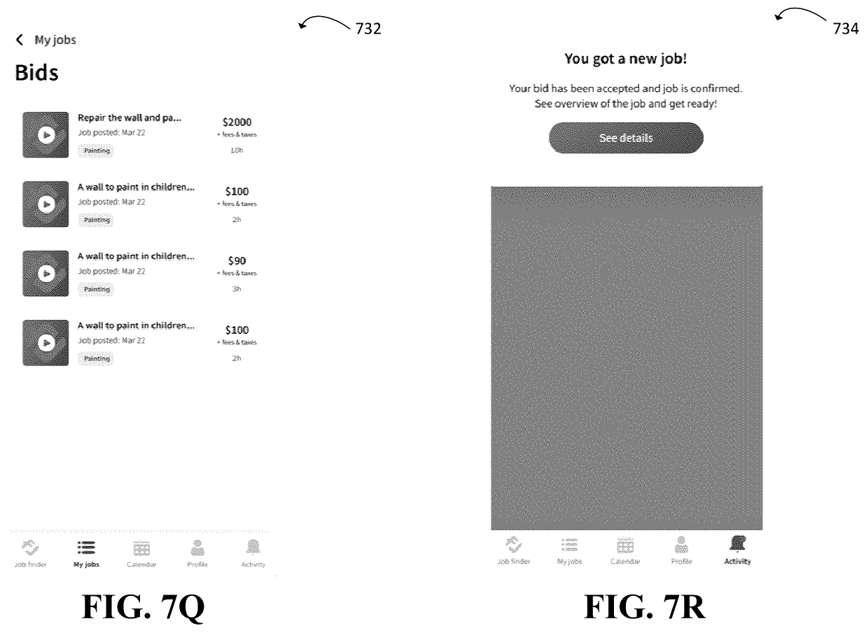

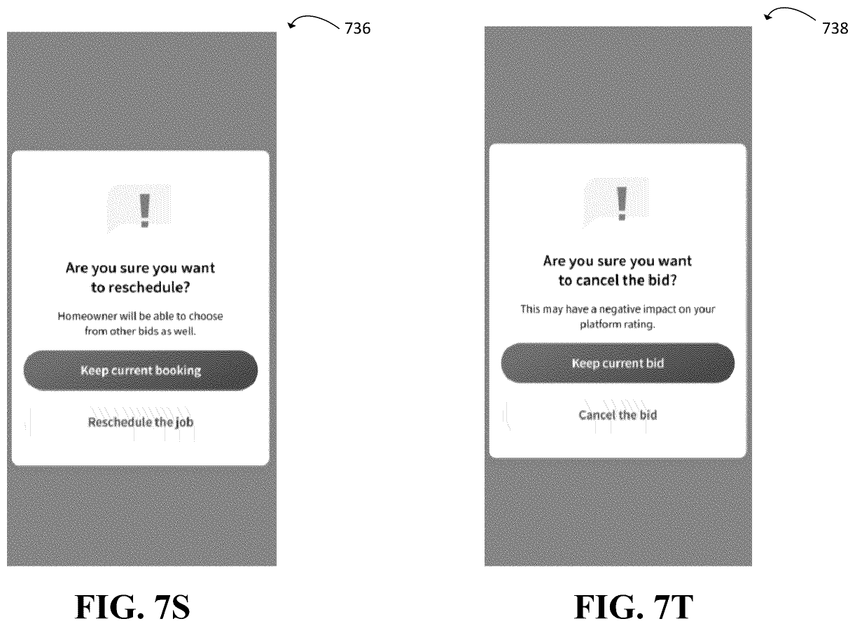

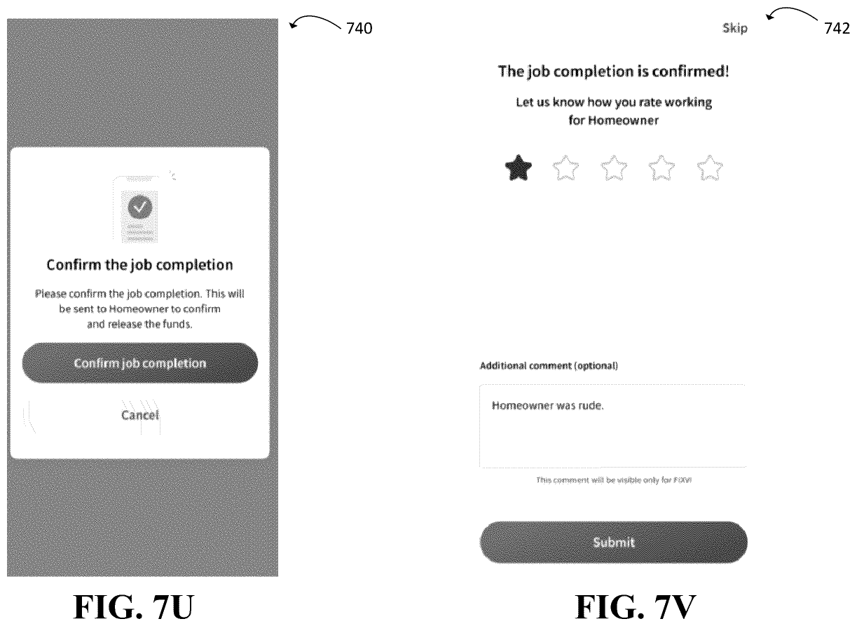

FIGS. 6A to 6M illustrate user interfaces that may be displayed at a project-defining device 110 and FIGS. 7A to 7V illustrate user interfaces that may be displayed at a project-seeker device 150. The user interfaces may also be referred to as user interface screens or screens. Some of the example screens may be displayed based on data received from the server 120 (FIG. 1). Some of the example screens may allow the associated device to interact with the server 120. Some of the example screens may include interface elements for receiving input or instructions. At least some such interface elements cause the associated device to communicate with the server 120.

Reference will first be made to FIGS. 6A to 6M, which may be displayed at a project-defining device 100. FIG. 6A illustrates an example interface screen 600 that may be used for uploading or capturing a video to be used as part of a project profile for a project to be performed at a physical location. In the illustrated example, the interface screen 600 includes a selectable option to capture a video (“Record a video”) and a selectable option to upload a previously-captured video (“Upload a video”). The example interface screen 600 may be provided as part of or may initiate the operation 402 of the methods 400, 500.

FIG. 6B illustrates an example user interface screen 602 that provides a notification displayed in response to a detected error. The notification is, in the illustrated example, a notification that a video was too long. The user interface screen 602 may be displayed as part of the error operation 505 of the method 500 of FIG. 5 when the server 120 determines that the video is too long at the operation 503.

FIG. 6C illustrates an example user interface 604 for receiving one or more parameters that are to be associated with a project profile (generated at operation 406 of methods 400, 500). The example user interface includes a selectable option for reviewing a captured video that is to be included in a project profile. The example user interface 604 lists a plurality of categories and one or more of the displayed categories may be toggled by the project-defining entity or otherwise selected to indicate a category of the project. The example user interface also includes an interface element, such as a text box, which allows for input of a title. The example user interface also includes an interface element for receiving input of an address for the project. The example user interface may include one or more interface elements for receiving input of other project parameters, such as project parameters of the types described herein. At least some such interface elements are off-screen in the illustrated example and may be exposed by scrolling. By way of example, the interface elements may include a text box or other interface element for inputting measurements. By way of further example, the interface elements may include a text box or other interface element for inputting a description. By way of further example, the interface elements may include a toggle switch or other interface element for indicating whether the project-defining entity has materials for the project. Other interface elements may be displayed instead of or in addition to the interface elements described above. Further, in some implementations, the user interface 604 may be adaptive so that some interface elements are selectively exposed or enabled based on activation of other interface elements. For example, when the user indicates that they have materials for the project, another interface element may be exposed for inputting such materials. In some implementations, the server 120 may cause one or more of the interface elements to be automatically populated or configured. Such automatic population or configuration may be based on the results of the automated video analysis described above. In at least some implements, the automatically populated data may act as default data that may be edited by interaction with the example user interface 604. In at least some implementations, project definition data, such as one or more parameters, may be provided to the server 120 from the project-defining device 110 through the user interface 604 at the operation 404.

FIG. 6D illustrates an example user interface 606 which allows a project-defining entity to view present, future and/or past projects. In the illustrated example, the user interface 606 includes a section for viewing scheduled projects (“Booked jobs”) and a section for viewing projects that have been posted by the project-defining entity but not scheduled (“Open for bids”). Indicators are displayed for indicating the number of applications (or bids) received for projects not yet accepted by the project-defining entity. Such projects are not yet accepted or scheduled. Each project may be selected or otherwise activated to view more details about the associated project.

FIG. 6E illustrates an example user interface 608 that allows a project-defining entity to cancel a project. The user interface 608 may include a warning message and a selectable option to proceed with the cancellation. The example user interface 608 also includes an option to proceed with the project.

FIG. 6F illustrates an example user interface 610 that allows a project-defining entity to input an instruction to reschedule a project that has already been scheduled with a project-seeking entity. The user interface 610 includes a warning message. The user interface 610 includes a selectable option to reschedule the project. The user interface 610 includes a selectable option to proceed with the project.

FIG. 6G illustrates an example user interface 612 that acts as a notification of an application to a project-defining entity when an application has been submitted by a project-seeking entity for a project previously defined by the project-defining entity. The notification includes a selectable option to review data related to the application (or bid).

FIG. 6H illustrates an example user interface 614 that provides detailed data to a project-defining entity of an application (or bid) for a project previously defined by that entity. The example user interface 614 includes one or more of: the username of the project-seeking entity, a message from the project-seeking entity regarding the project, a rating associated with the project-seeking entity, a value proposition such as a value parameter such as a price, and/or an estimated time to complete the project. The message regarding the project, price and estimated time may each be provided by the project-seeking entity. The example user interface 614 may, for example, be displayed responsive to activation of the selectable option to review data related to an application display in the user interface 612 of FIG. 6G. The example user interface 614 includes a selectable option to review a project-seeking entity's availability.

FIGS. 6I and 6J illustrate example user interfaces 616, 618 for reviewing a project-seeking entity's availability. One or more of the user interfaces 616, 618 may be displayed in response to activation of the selectable option to review the project-seeking entity's availability displayed in the user interface 614 of FIG. 6H (“Check availability”). Both of the user interfaces 616, 618 include a calendar display with selectable dates. In the example user interface 616 of FIG. 6I, the project-seeking entity is not available on the selected date and a message indicating the lack of availability is displayed. In the example user interface 618 of FIG. 6J, the project seeking entity is available on the selected data and so available time slots on that day are displayed. Such time slots are selectable.

FIG. 6K illustrates an example user interface 620. The example user interface 620 may be displayed after an application (or bid) has been received from a project-seeking entity and after a time slot has been selected by the project-defining entity. The example user interface 620 indicates the selected time slot. The example user interface 620 may indicate other details of the project or application, including a breakdown and total price to be paid by the project-defining entity for the project. The example user interface includes a selectable option for the project-defining entity to book the project with the project-seeking entity. In the illustrated example, the selectable option to book the project may be activated by sliding along a slide bar displayed in the example user interface 620.

FIG. 6L illustrates an example user interface 622. The example user interface 622 includes a selectable option for the project-defining entity to confirm that a previously booked project has been completed. In at least some implementations, this option may be selected to cause a payment associated with the project to be released to the project-seeking entity. In some implementations, the user interface 622 may be displayed automatically by the server 120 based on proximity to a scheduled project date. For example, at the end of the day on which a project was scheduled to be completed or at another predetermined time relative to such a date, the user interface 622 may be displayed. The example user interface also includes a selectable option to report an issue. This selectable option may, for example, be activated to provide an indication to the server 120 that the job was not completed or was not completed to the project-defining entity's satisfaction. This selectable option may, in at least some implementations, cause a scheduling user interface similar to the user interface of FIG. 6I or FIG. 6J to be displayed to allow for rescheduling.

FIG. 6M illustrates an example user interface 624 that allows a project-defining entity to submit a review of a project-seeking entity. The review may include a numerical rating and/or comments written in text. This interface 624 may only be displayed in some implementations after the project has been determined by the server 120 to have been completed.

Reference will now be made to FIGS. 7A to 7V, which illustrate example user interfaces for display on a project-seeker device 150. FIG. 7A illustrates an example interface 700 for initiating a search for a project. The example interface 700 includes interface elements for inputting one or more search parameters. By way of example, the interface elements may include a selectable list of categories. The interface elements may include a text box which may receive a search term. The server 120 may perform a matching operation such as the operation 408 of the methods 400, 500 of FIGS. 4 and 5 based on one or more search parameters received via the interface 700.

FIG. 7B illustrates an example user interface 702 that includes a notification of one or more projects that have been matched to the project-seeking entity. The example user interface 702 may be displayed as the notification of the operation 410 of the methods 400, 500 described above. The example user interface 702 includes a selectable option to refine one or more search parameters. In the illustrated example, the user interface 702 includes an option to refine a location parameter and an option to filter search results. One or more of the projects may be selectable to cause the user interface to be updated to display further parameters of the project. For example, selection of one of the projects may cause an indication of a selection of the selectable option to output further parameters for a particular project profile to be sent to the server 120 (operation 412 of FIGS. 4 and 5). The server 120 may then provide the further parameters to the project-seeker device 150 which may display such parameters in a user interface 708 of the type described below with reference to FIG. 7E.

FIG. 7C illustrates an example user interface 704 for receiving amended search parameters and, in the illustrated example, for configuring a sorting method of projects displayed in the search results. The user interface 704 allows the category or categories to be changed and allows a location to be changed. The user interface 704 may be displayed, for example, in response to activation of a selectable option displayed on the user interface of FIG. 7B, such as the option to filter search results.

FIG. 7D illustrates an example user interface 706 similar to the example user interface 702 of FIG. 7B. The difference between these user interfaces is that the user interface 706 of FIG. 7D illustrates a category-based search while the user interface 702 of FIG. 7B illustrates a keyword-based search based on user input to a free-form text box.

FIG. 7E illustrates a user interface 708 that includes details of a selected project. The selected project may be a project included in a notification (operation 410 in FIGS. 4 and 5). For example, the selected project may be a project that has been matched at an iteration of the operation 408 of one of the methods 400, 500 of FIG. 4 or 5. The example user interface 708 includes a selectable option to initiate an application for the project (“Bid on this job”). In the illustrated example, the user interface 708 includes a selectable option to output the video on the project-seeker device 150. Activation of this selectable option may cause the server 120 to receive (operation 412 of FIGS. 4 and 5) an indication of a selection of the selectable option to output the video on the project-seeker device 150. The user interface 708 may then be updated to display the video (at the operation 414 of FIGS. 4 and 5). In another scenario, refined search parameters may be sent to the server 120 via the user interface 708 and received at the operation 412 of FIGS. 4 and 5 which may then cause results of the refined search to be provided by the server 120 and displayed at the project-seeker device 150 at the operation 414 of FIGS. 4 and 5.

FIG. 7F illustrates an example user interface 710 for receiving data such as one or more project parameters or details of an application by a project-seeking entity to request to complete (or bid on) a project. In the illustrated example, the user interface 710 allows for input of a value parameter such as a price, a time parameter such as an estimated time to complete the project, and a comment regarding the project. The user interface 710 include a selectable option to proceed with the application. The selectable option may cause the application to be submitted or the selectable option may cause a further user interface 712 to be displayed. Such a further user interface 712 is illustrated in FIG. 7G. This user interface 712 may include a summary of the parameters of the application. The user interface 712 may include a selectable option to finalize the application (“Slide to post bid”). One or more value parameters may be sent to the server 120 using the user interface 170 at the operation 412 of FIGS. 4 and 5 and the project-seeker device 150 may then be notified, for example, by causing the project-seeker device 150 to output a user interface 612 of the type described with reference to FIG. 6G.

Referring to FIG. 7H, after the application has been submitted, the project-seeking entity may be notified of the posting and/or prompted to ensure that a calendar associated with their account has been updated with their availability. A user interface 714 that includes such a prompt is illustrated in FIG. 7H. This user interface 714 may include a selectable option to update a calendar (“Update calendar”).

A project-seeker may update their availability in response to activation of the selectable option in the user interface 714 or in response to selection of a selectable option displayed on another user interface. FIGS. 7I to 7P illustrate user interfaces for configuring availability. FIG. 7I illustrates a user interface 716 which includes a calendar highlighting the project-seeking entity's availability. A detailed daily view is displayed for a selected day. The detailed daily view indicated projects scheduled for the selected day. A selectable option to change availability for that day is also included on the display.

FIG. 7J illustrates a user interface 718 similar to the user interface 716 of FIG. 7I. The illustrated user interface 718 of FIG. 7J highlights that a selected day has been booked as a day off. That is, no projects are to be booked for the project-seeking entity on the day off. A selectable option to change availability for that day is also included on the display.

FIG. 7K illustrates a user interface 720 similar to the user interface 716 of FIG. 7I. The illustrated user interface 720 of FIG. 7K highlights that a selected day has availability but that no projects have been scheduled for the selected day. A selectable option to change availability for that day is also included on the display.

FIG. 7L illustrates a user interface 722 for configuring availability. The user interface 722 may be displayed in response to activation of the selectable option to change availability, such as the option displayed on one or more of the user interfaces 716, 718, 720 of FIGS. 7I, 7J, 7K. The user interface allows for input of a range of dates when they are to be available, allows for selection of the days of the week in which they are available and allows for input for time windows for accepting projects. The illustrated user interface 722 also includes a selectable option to define a buffer between projects, to permit a project-seeking entity with time to travel from one physical project location to another, or to account for unforeseen or unexpected delays in completing a project before starting another project. The buffer is a minimum amount of time that is to be reserved between projects.

FIG. 7M illustrates a user interface 724 for configuring availability and, more specifically, for defining one or more days off. The user interface 724 may include a selectable option to define one or more days that are to be scheduled as off or unavailable.

The server 120 (FIG. 1) may implement the availability configured through one or more of the user interfaces 7I to 7P. For example, this availability may be exposed to the project-defining entity in the user interfaces 616, 618 of FIGS. 6I and 6J.

FIG. 7N illustrates a user interface 726 that includes a notification. The notification may be generated by the server 120 to confirm that one or more slots or days have been booked as off days, for example, using the user interface 724 of FIG. 7M.

FIG. 7O illustrates a user interface 728 that includes a notification. The notification may be generated by the server 120 in response to detecting that one or more time periods or days booked off overlaps with one or more previously scheduled projects. The user interface 728 may include a selectable option to change the days off and/or a selectable option to reschedule or cancel the overlapping project(s).

FIG. 7P illustrates a user interface 730 that includes a notification. The notification may be generated when new calendar settings are applied that affect previously-scheduled projects. The user interface 728 may include a selectable option to change the calendar settings and/or a selectable option to reschedule or cancel the affected project(s).

FIG. 7Q illustrates a user interface 732 that includes an application (“Bids”) list. The application list is a list of applications that have been submitted by the project-seeking entity. Each of the applications may be selected to display details about each application or to manage an application; for example, by changing parameters of the application, cancelling the application, etc.

FIG. 7R illustrates a user interface 734 that includes a notification. The user interface 734 may be displayed when the server 120 detects that an application previously submitted by a project-seeking entity has been accepted and/or scheduled by a project-defining entity.

FIG. 7S illustrates an example user interface 736 that includes a notification. The user interface 736 may be displayed in response to input by a project-seeking entity of a request to reschedule a project. When such a request is received, the notification may indicate that the project-defining entity may select a different application if the request to reschedule the project is submitted. If the request to proceed with rescheduling the project is received via the user interface 736, then the server may send a notification to the project-defining entity and the notification may allow the project defining entity to select a different application from a different project-seeking entity or to reschedule the project with the same project-seeking entity.

FIG. 7T illustrates an example user interface 738 that includes a notification. The user interface 738 may be displayed in response to input by a project-seeking entity of a request to cancel a project. When such a request is received, the notification may indicate that cancellation may affect a rating associated with the project-seeker account. If a request to proceed with the cancellation is received via the user interface 738, the server 120 may automatically negatively adjust a rating associated with the project-seeker account.

FIG. 7U illustrates an example user interface 740. The example user interface 740 includes a selectable option to confirm that a previously-booked project has been completed. In at least some implementations, this option may be selected by the project-seeking entity to cause a notification to be sent to the project-defining entity to confirm that the project has been completed. By way of example, selection of this option may cause a user interface 622 of the type illustrated in FIG. 6L to be displayed on the project-defining device 110.

FIG. 7V illustrates an example user interface 742 that allows a project-seeking entity to submit a review of a project-defining entity. This interface 742 may only be displayed, in some implementations, after the server 120 determines that the project has been completed. The server 120 may determine that the project has been completed when the project-defining entity confirms completion. The server 120 may, in some implementations, when the project-seeking entity confirms completion, notify the project-defining entity that the project-seeking entity has confirmed completion. The server 120 may then wait until a defined period of time has elapsed following such notification. If the project-defining entity does not indicate that the project has not been completed within that period of time, the server 120 may determine that the project has been completed.

In some implementations, video or image data may be uploaded to the server 120 by the project-seeking device 150 as proof of completion of the project and the server 120 may determine that the project has been completed based on an automated analysis the video or image data. For example, the automated video analysis may rely on both the video data received at the server 120 as proof of completion and also the video data received at the server 120 at the operation 402 of the method 400, 500 of FIG. 4 or 5. For example, the analysis may include verifying that a work environment depicted in the original video data has been modified, repaired, maintained or improved in the video that represents the proof of completion. The analysis may be performed at or by a machine learning module. In some implementations, the analysis may verify that the work environment depicted in the original video corresponds to the work environment depicted in the video that represents proof of completion. In some implementations, the analysis may verify that a location defined in metadata associated with the video representing proof of completion corresponds to the location of the project.

In at least some implementations, when the server 120 determines that the project has been completed, it may trigger a transfer such as a payment to the project-seeking entity.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer-implemented method performed at a server, the method comprising:
receiving, at the server and from a remote computing device, video data defining a video purporting to include at least one scene of a work environment for a project to be performed at a physical location;
obtaining project definition data defining one or more parameters of the project;
generating a project profile based on at least a portion of the video data and at least a portion of the project definition data;
matching the project profile to at least one project-seeker account; and
generating a notification of the project associated with the project profile on a computing device associated with the matched project-seeker account.

2. The computer-implemented method of claim 1, wherein matching the project profile to the project-seeker account includes matching the project profile based on at least some data extracted from the video data.

3. The computer-implemented method of claim 1, wherein the notification of the project includes a selectable option to initiate an application for the project.

4. The computer-implemented method of claim 3, further comprising:
receiving, at the server and from the computing device associated with the matched project-seeker account, application video data defining an application video purporting to include parameters of the application; and
generating the application based on at least a portion of the application video data.

5. The computer-implemented method of claim 1, wherein obtaining project definition data includes obtaining one or more of the parameters of the project based on the video data.

6. The computer-implemented method of claim 5, wherein obtaining one or more of the parameters of the project based on the video data includes obtaining input from the remote computing device and verifying at least a portion of the obtained input based on the video data.

7. The computer-implemented method of claim 5, wherein obtaining one or more of the parameters of the project based on the video data includes obtaining one or more of the parameters based on metadata included in the video data.

8. The computer-implemented method of claim 7, wherein obtaining one or more of the parameters of the project based on the video data includes obtaining location data representing the physical location at which the project is to be performed based on a location defined in the metadata included in the video data.

9. The computer-implemented method of claim 5, wherein obtaining one or more of the parameters of the project based on the video data includes passing the video data to a speech-to-text module that performs speech recognition to obtain text data and where one or more of the parameters are obtained from the text data.

10. The computer-implemented method of claim 9, wherein obtaining one or more of the parameters of the project based on the video data includes passing at least a portion of the text data to a machine learning module trained to identify one or more of the parameters.

11. The computer-implemented method of claim 5, wherein the one or more of the parameters of the project obtained from the video data includes one or more of:
a category parameter defining a category of the project;
a time parameter defining one or more timing preferences for the project;
a material parameter defining a material to be used in performing the project;
a tool parameter defining a tool to be used in performing the project;
a size parameter for the project; and
a location parameter defining a location at which the project is to be performed.

12. The computer-implemented method of claim 5, wherein obtaining the one or more parameters of the project based on the video data includes performing an automated image analysis of one or more frames of the video.

13. The computer-implemented method of claim 12, wherein performing the automated image analysis of one or more frames of the video includes passing at least a portion of the video data to a machine learning module trained to identify the one or more project parameters.

14. The computer-implemented method of claim 13, wherein performing the automated image analysis of one or more frames of the video includes determining one or more size parameters as a parameter of the project based on the one or more frames of the video.

15. The computer-implemented method of claim 14, wherein obtaining the one or more parameters of the project based on the video data includes identifying a quantum of a material to be used in performing the project based on the one or more size parameters.

16. The computer-implemented method of claim 1, wherein the notification of the project includes a selectable option to output the video on the computing device and wherein the method further includes:
receiving, at the server, an indication of selection of the selectable option to output the video on the computing device; and
in response to receiving the indication of selection of the selectable option to output the video on the computing device, serving at least a portion of the video to the computing device for output thereon.

17. The computer-implemented method of claim 1, further comprising:
comparing one or more of the parameters of the project to a representation of related parameters of one or more other projects of a same category; and
selectively generating a notification at the remote computing device based on a result of the comparing.

18. The computer-implemented method of claim 1, wherein the video data is second video data and wherein the method further includes:
receiving, at the server and from the remote computing device, first video data defining a first video purporting to include at least one scene of the work environment for the project to be performed at the physical location;
determining, based on the first video data and a threshold length parameter, that the first video is too long; and
in response to determining that the first video is too long, generating a notification at the remote computing device.

19. A server comprising:
a communications system;
a memory; and
a processor coupled to the communications system and the memory, the memory having stored thereon processor-executable instructions which, when executed, configure the processor to cause the server to:
receive, from a remote computing device, video data defining a video purporting to include at least one scene of a work environment for a project to be performed at a physical location;
obtain project definition data defining one or more parameters of the project;
generate a project profile based on at least a portion of the video data and at least a portion of the project definition data;
match the project profile to at least one project-seeker account; and
generate a notification of the project associated with the project profile on a computing device associated with the matched project-seeker account.

20. A non-transitory computer-readable storage medium comprising computer-executable instructions which, when executed, configure a server to:
receive, from a remote computing device, video data defining a video purporting to include at least one scene of a work environment for a project to be performed at a physical location;
obtain project definition data defining one or more parameters of the project;
generate a project profile based on at least a portion of the video data and at least a portion of the project definition data;
match the project profile to at least one project-seeker account; and
generate a notification of the project associated with the project profile on a computing device associated with the matched project-seeker account.
